(19) United States
(12) Patent Application Publication
(10) Pub. No.: US 2020/0406241 A1
(43) Pub. Date: Dec. 31, 2020

(54) OXYGEN REDUCTION CATALYST

(71) Applicants: SHOWA DENKO K.K., Tokyo (JP); NATIONAL UNIVERSITY CORPORATION YOKOHAMA NATIONAL UNIVERSITY, Yokohama-shi, Kanagawa (JP)

(72) Inventors: Kunchan LEE, Tokyo (JP); Yoshinori YAMATO, Tokyo (JP); Kenichiro OTA, Yokohama-shi (JP); Akimitsu ISHIHARA, Yokohama-shi (JP)

(73) Assignees: SHOWA DENKO K.K., Tokyo (JP); NATIONAL UNIVERSITY CORPORATION YOKOHAMA NATIONAL UNIVERSITY, Yokohama-shi, Kanagawa (JP)

(21) Appl. No.: 16/472,440

(22) PCT Filed: Dec. 22, 2017
(86) PCT No.: PCT/JP2017/046108

§ 371 Date: Jun. 21, 2019

(30) Foreign Application Priority Data
Dec. 22, 2016 (JP) 2016-249352

(51) Int. Cl. B01J 27/24; H01M 4/90; H01M 8/1004

(52) U.S. Cl. CPC B01J 27/24; H01M 8/1004; H01M 4/9091; H01M 4/9016

(57) ABSTRACT

An object of the invention is to provide an oxygen reduction catalyst composed of a titanium oxynitride having high oxygen reduction capacity. The oxygen reduction catalyst of the invention is a titanium oxynitride that has a nitrogen element content of 0.1 to 2.0 mass %, has a crystal structure of rutile titanium dioxide in a powder X-ray diffraction measurement, and has a signal intensity ratio N—Ti—N/O—Ti—N in an X-ray photoelectron spectroscopic analysis of in the range of 0.01 to 0.50. Further, the oxygen reduction catalyst of the invention is a titanium oxynitride that includes titanium oxide particles, has a crystal structure of rutile titanium dioxide, and has an amorphous layer in a surface layer of the titanium oxide particles.

### TECHNICAL FIELD

The present invention relates to an oxygen reduction catalyst composed of a titanium oxynitride.

### BACKGROUND ART

A titanium oxide is used as a photocatalyst or a catalyst involved in an oxidation-reduction reaction. Especially, it is known that it can also be used as an electrode catalyst of a fuel cell by utilizing the oxygen reduction catalytic capacity of a titanium oxide catalyst.

In Patent Document 1, it has been reported that by heat-treating a metal carbonitride or a metal nitride in the presence of oxygen and hydrogen to create an oxygen defect in which oxygen is replaced with another element, the active site and electroconductivity can be secured, and therefore a titanium oxide catalyst having high oxygen reduction catalytic capacity can be produced.

In Patent Document 2, it has been reported that an oxide catalyst with high oxygen reduction catalytic capacity can be produced by sputtering a metal oxide such as TiO₂, to give an oxygen reduction electrode having an oxygen defect for a direct fuel cell.

In Non Patent Document 1, it has been reported that a titanium oxide catalyst having high oxygen reduction catalytic capacity can be produced by heat-treating a titanium plate in a nitrogen atmosphere containing a trace amount of oxygen, and that the activity develops in a rutile titanium dioxide component.

In Non Patent Document 2, it has been reported that a titanium oxide catalyst having high oxygen reduction catalytic capacity can be produced by heat-treating a titanium carbonitride (TiC_{0.82}N_{0.23}O_{0.06}) in a mixed atmosphere of hydrogen, oxygen, and nitrogen to yield a titanium compound (TiC_{0.21}N_{0.01}O_{1.88}), and further heat-treating this titanium compound in an ammonia gas atmosphere. Further, a powder has been prepared by heat-treating a titanium oxide having a rutile titanium dioxide structure in an ammonia gas atmosphere, and used as a reference in a comparison of oxygen reduction catalytic capacity.

The method of Patent Document 1 obtains an active site by replacing oxygen with another element, and is characterized that the crystal lattice is expanded when an oxygen defect is created. Therefore, the catalyst described in Patent Document 1 is unstable in the strongly acidic condition during a fuel cell operation, and is likely to be eluted, which is not preferable in terms of durability.

The method of Patent Document 2 prepares a catalyst in which oxygen atoms inside the metal oxide are decreased without replacement with another element, and does not prepare a catalyst with an oxygen defect generated by replacement with nitrogen. Meanwhile, since it is first prepared as a thin film by sputtering, it is difficult to obtain a necessary amount for a catalyst having a large specific surface area such as a powder, which is not preferable.

The titanium oxide catalyst described in Non Patent Document 1 is produced by a heat treatment at 900 to 1000° C. in an oxygen gas atmosphere containing a nitrogen gas, and has a rutile titanium dioxide crystal structure. The results of XRD and XPS measurements show that this titanium oxide catalyst has a surface with a higher oxidation state compared to a titanium oxide catalyst obtained by a heat treatment at low temperature. However, according to the report of Non Patent Document 1, a catalyst having an oxygen defect generated by replacement with nitrogen has not been prepared.

In the preparation method of titanium oxycarbonitride in Non Patent Document 2, in which preparation method an active site is obtained by replacing oxygen with another element, a strain tends to be generated in the crystal lattice, because carbon is contained in the catalyst in addition to titanium, oxygen, and nitrogen to increase the kinds of elements having different atomic radii. Therefore, the catalyst described in Non Patent Document 2 is unstable in the strongly acidic condition during a fuel cell operation, and is likely to be eluted, which is not preferable in terms of durability. Further, with respect to the ammonia-treated rutile titanium oxide for a reference, since a preparation method is general, the signal intensity ratio N—Ti—N/O—Ti—N in an X-ray photoelectron spectroscopic analysis exceeds 0.50 indicating a high titanium nitride content. As a result, the catalytic activity is lowered, and the spontaneous potential is also about 0.4V.

### CITATION LIST

### Patent Documents

Patent Document 1: JP 2011-194328 A
Patent Document 2: Japanese Patent No. 5055557

### Non Patent Documents

Non Patent Document 1: Electrochimica Acta, 2007, 52, 2492-2497
Non Patent Document 2: Electrochimica Acta, 2013, 88, 697-707

### SUMMARY OF INVENTION

### Technical Problem

The present invention aims to solve such problems in the conventional technologies.

That is, an object of the present invention is to provide an oxygen reduction catalyst composed of a titanium oxynitride having high oxygen reduction capacity.

### Solution to Problem

The present invention relates to the following [1] to [14].

[1] An oxygen reduction catalyst being a titanium oxynitride that has a nitrogen element content of 0.1 to 2.0 mass %, has a crystal structure of rutile titanium dioxide in a powder X-ray diffraction measurement, and has a signal intensity ratio of N—Ti—N/O—Ti—N in an X-ray photoelectron spectroscopic analysis of in the range of 0.01 to 0.50.

[2] The oxygen reduction catalyst according to [1] above, wherein each of |a1-a0|, |b1-b0|, and |c1-c0| is 0.005 Å or less, when a1, b1, and c1 represent lattice constants a, b, and c, respectively, of the titanium oxynitride, and a0, b0, and c0 represent lattice constants a, b, and c, respectively, of rutile titanium dioxide consisting solely of titanium and oxygen.

[3] An electrode catalyst for a fuel cell, composed of the oxygen reduction catalyst according to [1] or [2] above.

[4] A fuel cell electrode comprising a catalyst layer comprising the electrode catalyst for a fuel cell according to [3] above.

[5] A membrane electrode assembly comprising a cathode, an anode, and a polymer electrolyte membrane placed between the cathode and the anode, wherein at least either of the cathode and the anode is the fuel cell electrode according to [4] above.

[6] A fuel cell comprising the membrane electrode assembly according to [5] above.

[7] An oxygen reduction catalyst comprising titanium oxide particles, wherein the oxygen reduction catalyst is a titanium oxynitride that has a crystal structure of rutile titanium dioxide in a powder X-ray diffraction measurement, and has an amorphous layer in a surface layer having a thickness of 10 nm of the titanium oxide particles when observed with a transmission electron microscope.

[8] The oxygen reduction catalyst according to [7] above further having a crystal structure of Ti₄O₇ in the surface layer having a thickness of 10 nm, when observed with a transmission electron microscope.

[9] The oxygen reduction catalyst according to [8] above further having a crystal structure of cubic titanium nitride in the surface layer having a thickness of 10 nm, when observed with a transmission electron microscope.

[10] The oxygen reduction catalyst according to [8] above not having a crystal structure of cubic titanium nitride in the surface layer having a thickness of 10 nm, when observed with a transmission electron microscope.

[11] An electrode catalyst for a fuel cell, composed of the oxygen reduction catalyst according to [7] to [10] above.

[12] A fuel cell electrode comprising a catalyst layer comprising the electrode catalyst for a fuel cell according to [11] above.

[13] A membrane electrode assembly comprising a cathode, an anode, and a polymer electrolyte membrane placed between the cathode and the anode, wherein at least either of the cathode and the anode is the fuel cell electrode according to [12] above.

[14] A fuel cell comprising the membrane electrode assembly according to [13] above.

### Advantageous Effects of Invention

By using the oxygen reduction catalyst of the present invention as an electrode catalyst for a fuel cell, it becomes possible to obtain a fuel cell having high oxygen reduction capacity.

### BRIEF DESCRIPTION OF DRAWINGS

FIG. 1 shows an X-ray diffraction spectrum of the oxygen reduction catalyst (1) of Example 1.

FIG. 2 shows a Ti2p XPS spectrum of the oxygen reduction catalyst (1) of Example 1.

FIG. 3 shows an X-ray diffraction spectrum of the oxygen reduction catalyst (2) of Example 2.

FIG. 4 shows a Ti2p XPS spectrum of the oxygen reduction catalyst (2) of Example 2.

FIG. 5 shows an X-ray diffraction spectrum of the oxygen reduction catalyst (3) of Example 3.

FIG. 6 shows a Ti2p XPS spectrum of the oxygen reduction catalyst (3) of Example 3.

FIG. 7 shows an X-ray diffraction spectrum of the oxygen reduction catalyst (4) of Example 4.

FIG. 8 shows a Ti2p XPS spectrum of the oxygen reduction catalyst (4) of Example 4.

FIG. 9 shows an X-ray diffraction spectrum of the oxygen reduction catalyst (5) of Example 5.

FIG. 10 shows a Ti2p XPS spectrum of the oxygen reduction catalyst (5) of Example 5.

FIG. 11 shows an X-ray diffraction spectrum of the oxygen reduction catalyst (6) of Example 6.

FIG. 12 shows a Ti2p XPS spectrum of the oxygen reduction catalyst (6) of Example 6.

FIG. 13 shows an X-ray diffraction spectrum of the oxygen reduction catalyst (7) of Example 7.

FIG. 14 shows a Ti2p XPS spectrum of the oxygen reduction catalyst (7) of Example 7.

FIG. 15 shows an X-ray diffraction spectrum of the oxygen reduction catalyst (c1) of Comparative Example 1.

FIG. 16 shows a Ti2p XPS spectrum of the oxygen reduction catalyst (c1) of Comparative Example 1.

FIG. 17 shows an X-ray diffraction spectrum of the oxygen reduction catalyst (c2) of Comparative Example 2.

FIG. 18 shows a Ti2p XPS spectrum of the oxygen reduction catalyst (c2) of Comparative Example 2.

FIG. 19 shows an X-ray diffraction spectrum of the oxygen reduction catalyst (c3) of Comparative Example 3.

FIG. 20 shows a Ti2p XPS spectrum of the oxygen reduction catalyst (c3) of Comparative Example 3.

FIG. 21 shows an X-ray diffraction spectrum of the oxygen reduction catalyst (c4) of Comparative Example 4.

FIG. 22 shows a Ti2p XPS spectrum of the oxygen reduction catalyst (c4) of Comparative Example 4.

FIG. 23 shows an X-ray diffraction spectrum of the oxygen reduction catalyst (c5) of Comparative Example 5.

FIG. 24 shows a Ti2p XPS spectrum of the oxygen reduction catalyst (c5) of Comparative Example 5.

FIG. 25 shows an X-ray diffraction spectrum of the oxygen reduction catalyst (c6) of Comparative Example 6.

FIG. 26 shows a Ti2p XPS spectrum of the oxygen reduction catalyst (c6) of Comparative Example 6.

FIG. 27 shows an X-ray diffraction spectrum of the oxygen reduction catalyst (c7) of Comparative Example 7.

FIG. 28 shows a Ti2p XPS spectrum of the oxygen reduction catalyst (c7) of Comparative Example 7.

FIG. 29 shows an electron diffraction pattern obtained by observation with a transmission electron microscope of the oxygen reduction catalyst (5) of Example 5. The crystal structures of a titanium oxide of Ti₄O₇ and a cubic titanium nitride are recognizable together with the rutile crystal structure.

FIG. 30 shows transmission electron micrographs (a) and (b) of the oxygen reduction catalyst (5) of Example 5. It is recognizable that the catalyst has an amorphous layer in the surface layer of a titanium oxide particle. In this regard, an area where the amorphous layer exists is circled with a broken line.

FIG. 31 shows an electron diffraction pattern obtained by observation with a transmission electron microscope of the oxygen reduction catalyst (1) of Example 1. The crystal structures of a titanium oxide of Ti₄O₇ and a cubic titanium nitride are recognizable together with the rutile crystal structure.

FIG. 32 shows transmission electron micrographs (a) and (b) of the oxygen reduction catalyst (1) of Example 1. An amorphous layer is recognizable in the surface layer of a titanium oxide particle. In this regard, an area where the amorphous layer exists is circled with a broken line.

FIG. 33 shows an electron diffraction pattern obtained by observation with a transmission electron microscope of the oxygen reduction catalyst (c6) of Comparative Example 6. The crystal structures of rutile, a titanium oxide of Ti₄O₇ and a cubic titanium nitride are recognizable together with the anatase crystal structure.

FIG. 34 shows transmission electron micrographs (a) and (b) of the oxygen reduction catalyst (c6) of Comparative Example 6. An amorphous layer is recognizable in the surface layer of a titanium oxide particle. In this regard, an area where the amorphous layer exists is circled with a broken line.

FIG. 35 shows an electron diffraction pattern obtained by observation with a transmission electron microscope of the oxygen reduction catalyst (c7) of Comparative Example 7. The crystal structures of rutile, a titanium oxide of Ti₄O₇, and a cubic titanium nitride are recognizable together with the brookite crystal structure.

FIG. 36 shows transmission electron micrographs (a) and (b) of the oxygen reduction catalyst (c7) of Comparative Example 7. An amorphous layer is recognizable in the surface layer of a titanium oxide particle. In this regard, an area where the amorphous layer exists is circled with a broken line.

FIG. 37 shows an electron diffraction pattern obtained by observation with a transmission electron microscope of the oxygen reduction catalyst (5) of Example 5 treated with sulfuric acid. The crystal structure of a titanium oxide of Ti₄O₇ is recognizable together with the rutile crystal structure.

FIG. 38 shows transmission electron micrographs (a) and (b) of the oxygen reduction catalyst (5) of Example 5 treated with sulfuric acid. The catalyst has an amorphous layer in the surface layer of a titanium oxide particle, and further the crystal structure of a titanium oxide of Ti₄O₇ is recognizable. In this regard, an area where the amorphous layer exists is circled with a broken line.

### DESCRIPTION OF EMBODIMENTS

### [Oxygen Reduction Catalyst]

An oxygen reduction catalyst of the present invention is a titanium oxynitride that has a nitrogen element content of 0.1 to 2.0 mass %, has a crystal structure of rutile titanium dioxide in a powder X-ray diffraction measurement, and has a signal intensity ratio N—Ti—N/O—Ti—N in an X-ray photoelectron spectroscopic analysis of in the range of 0.01 to 0.50. In other words, the oxygen reduction catalyst of the present invention may be an oxygen reduction catalyst composed of a specific titanium oxynitride. However, this does not strictly exclude the presence of impurities in the oxygen reduction catalyst of the present invention, and inevitable impurities originated from raw materials and/or production process, or other impurities to the extent the characteristics of the catalyst be not impaired may be included in the oxygen reduction catalyst of the present invention.

“Titanium oxynitride” as used herein means collectively substances that contain, as a whole, only titanium, nitrogen and oxygen as constituent elements, and are composed of one or two or more compound species.

In this regard, “oxygen reduction catalyst containing titanium oxide” is herein occasionally referred to as “titanium oxide catalyst”.

Possible crystal structures of the titanium oxynitride composing the oxygen reduction catalyst of the present invention include a crystal structure of rutile titanium dioxide, a crystal structure of anatase titanium dioxide, and a crystal structure of brookite titanium dioxide. These crystal structures may be identified by the presence of peaks or appearance patterns peculiar to the respective crystal structures in an X-ray diffraction spectrum obtained from a powder X-ray diffraction measurement.

In the crystal structure of rutile titanium dioxide, a pattern tends to appear in which a large peak appears at a position of 2θ=27° to 28°, but a peak does not appear at a position of 2θ=30° to 31°.

On the other hand, in the crystal structure of anatase titanium dioxide, a large peak tends to appear at a position of 2θ=25° to 26°.

Further, in the crystal structure of brookite titanium dioxide, a large peak tends to appear at a position of 2θ=25° to 26°, and another peak also tends to appear at a position of 2θ=30° to 31°. Therefore, the crystal structure of brookite titanium dioxide can be discriminated from the crystal structure of anatase titanium dioxide by the presence or absence of a peak at a position of 2θ=30° to 31°.

Meanwhile, in the case of a titanium oxynitride having a high nitrogen element content, a crystal structure based on titanium nitride may be sometimes included. In this case, as seen in Comparative Examples 1 to 4 described later, peaks tend to appear at a position of 20=37° to 38° and a position of 20=43° to 44°.

Having the crystal structure of rutile titanium dioxide as used herein means that when the total amount of titanium compound crystals confirmed in an X-ray diffraction measurement is taken as 100 mol %, the content of rutile titanium dioxide (hereinafter occasionally referred to as “rutile content ratio”) is confirmed to be 90 mol % or more. The rutile content ratio is a value measured by XRD as described later.

For securing acid resistance during a fuel cell operation, the crystal structure of the above rutile titanium dioxide preferably has lattice constants less changed from those of rutile titanium dioxide composed solely of titanium and oxygen (namely rutile titanium dioxide not containing nitrogen) and retains the crystal lattice of a titanium dioxide that is thermodynamically stable. Specifically, when a1, b1 and c1 represent the lattice constants a, b and c, respectively, of the titanium oxynitride, and a0, b0, and c0 represent the lattice constants a, b and c, respectively, of the rutile titanium dioxide consisting solely of titanium and oxygen (which may be referred to herein also as the “standard rutile titanium dioxide”), each of |a1-a0|, |b1-b0|, and |c1-c0| is preferably 0.005 Å (0.0005 nm) or less.

The lattice constants a, b, and c can be determined by a Rietveld analysis of a powder X-ray diffraction spectrum.

The nitrogen element content is preferably in the range of 0.1 to 2.0 mass %, and more preferably in the range of 0.5 to 1.0 mass %. When the nitrogen element content is less than the above lower limit value, the titanium oxide is in an insufficiently nitrided state, and formation of catalytic active sites tends to be insufficient. A state in which the nitrogen element content is higher than the above upper limit value is a state in which titanium nitride unstable under an acidic condition is generated, and the function as a catalyst tends to be lost rapidly during a fuel cell operation.

With respect to a titanium oxynitride composing the oxygen reduction catalyst of the present invention, the signal intensity ratio N—Ti—N/O—Ti—N in the X-ray photoelectron spectroscopic analysis is preferably 0.01 to 0.50, and more preferably 0.1 to 0.20. When the signal intensity ratio N—Ti—N/O—Ti—N is smaller than the above lower limit value, the titanium oxide is in an insufficiently nitrided state, and formation of catalytic active sites tends to be insufficient. On the other hand, a titanium oxynitride, in which the signal intensity ratio N—Ti—N/O—Ti—N is larger than the above upper limit value, contains a large amount of titanium nitride as a constituent compound species. Since titanium nitride is unstable under acidic conditions, when a titanium oxynitride containing a large amount of titanium nitride as a constituent compound species is used as an oxygen reduction catalyst, its function as a catalyst tends to be lost rapidly during a fuel cell operation.

The signal intensity ratio N—Ti—N/O—Ti—N can be specifically obtained in the following way: an X-ray photoelectron spectroscopic analysis is conducted to give a Ti2p XPS spectrum, wherein the bond energy is corrected based on the peak position attributable to a hydrocarbon chain of the C1s XPS spectrum as 284.6 eV; the intensity value of the Ti2p XPS spectrum at 455.5 eV is adopted as the intensity of N—Ti—N, and the intensity value at 458.3 eV is adopted as the intensity of O—Ti—N; and the signal intensity ratio N—Ti—N/O—Ti—N can be obtained as a signal intensity ratio of the intensity values.

[Observation with Transmission Electron Microscope and Electron Diffraction Pattern]

The inventors have further examined the structure of the oxygen reduction catalyst of the present invention, and found that the oxygen reduction catalyst of the present invention contains titanium oxide particles, and has a specific structure in the surface layer of the titanium oxide particles as described in the Examples below.

The oxygen reduction catalyst of the present invention contains titanium oxide particles, and has a crystal structure of rutile titanium dioxide in a powder X-ray diffraction measurement. Further, when observed with a transmission electron microscope (TEM), the catalyst has an amorphous layer of titanium oxide in a surface layer having a thickness of 10 nm of the titanium oxide particles. In this regard, the “surface layer having a thickness of 10 nm of a titanium oxide particle” means a region within a depth of 10 nm from the surface of the titanium oxide particle. Having the crystal structure of rutile titanium dioxide in a powder X-ray diffraction measurement means as described above.

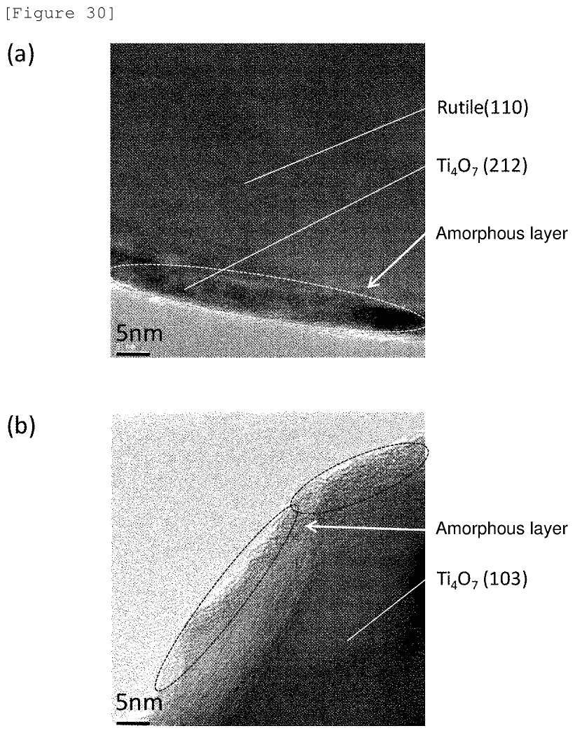

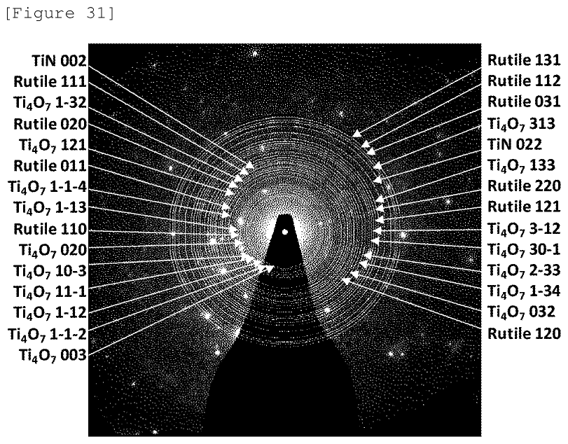

When observed with TEM, an amorphous layer of titanium oxide is observed in the surface layer of the titanium oxide particles constituting the oxygen reduction catalyst of the present invention. To be precise, as shown in the TEM photograph of FIG. 30, etc., in the surface layer having a thickness of 10 nm of a titanium oxide particle, there are a streaky pattern corresponding to the crystal structure of, for example, a titanium oxide of Ti₄O₇ and an amorphous part that does not show a pattern such as streaks. The crystal structure of the titanium oxide of Ti₄O₇ is not observed in the powder X-ray diffraction measurement described above, because it is present in the surface layer having a thickness of 10 nm and its content is not high. It is conceivable that the oxygen reduction catalyst of the present invention can have an oxygen defect structure, because it has an amorphous layer in the surface layer having a thickness of 10 nm of a titanium oxide particle.

In the electron diffraction pattern acquired in a TEM observation, as shown in the electron diffraction pattern of FIG. 29, etc., it can be confirmed that the oxygen reduction catalyst of the present invention has the crystal structure of a titanium oxide of Ti₄O₇.

It is conceivable that the oxygen reduction catalyst of the present invention has acid resistance when used as a fuel cell catalyst, because it is constituted with titanium oxide particles having the crystal structure of rutile titanium dioxide, and that it becomes an oxygen reduction catalyst having high catalytic activity, because it has oxygen defects specified by the crystal structure of Ti₄O₇ in the surface layer having a thickness of 10 nm of titanium oxide particles.

Further, in an electron diffraction pattern to be acquired in a TEM observation, as shown in the electron diffraction pattern of FIG. 29, etc., it can be confirmed that the oxygen reduction catalyst of the present invention has also the crystal structure of cubic titanium nitride. The crystal structure of cubic titanium nitride is not observed in a powder X-ray diffraction measurement described above, because it is present in the surface layer having a thickness of 10 nm and its content is not high. In other words, in an embodiment of the present invention, the oxygen reduction catalyst of the present invention has the crystal structure of cubic titanium nitride in the surface layer having a thickness of 10 nm. This crystal structure of cubic titanium nitride is eliminated by performing a sulfuric acid treatment described later. However, as described later in the section of “Sulfuric acid treatment”, the oxygen reduction catalyst of the present invention does not lose high catalytic activity, even when it loses the crystal structure of cubic titanium nitride. In other words, in another embodiment of the present invention, the oxygen reduction catalyst of the present invention may not have the crystal structure of cubic titanium nitride in the surface layer having a thickness of 10 nm.

### [Method for Producing Oxygen Reduction Catalyst]

The oxygen reduction catalyst of the present invention may be obtained by using titanium oxide as a raw material, raising its temperature at 40 to 80° C./min in an ammonia gas stream, and calcining it at 500 to 1000° C.

Detailed conditions are described below.

### (Raw Material: Titanium Oxide)

The titanium oxide used as a raw material in the production method of the present invention is preferably at least one selected from the group consisting of a titanium dioxide, a reduced titanium oxide, such as Ti₃O₄, Ti₄O₇, and Ti₃O₅, and a hydroxylated titanium, such as TiO(OH), and especially preferably rutile titanium dioxide. However, this does not mean to exclude titanium compounds other than rutile titanium dioxide from the titanium oxides. For example, anatase titanium dioxide begins to undergo phase transition to rutile titanium dioxide, when it is heated at 800° C. or higher. Taking the above into consideration, the titanium oxide that can be used as a raw material in the production method of the present invention may be a titanium oxide such as anatase titanium dioxide that undergoes phase transition to rutile titanium dioxide by heating, or the like.

These titanium oxides may be used singly or in combinations of two or more thereof.

### (Calcination Conditions)

According to the present invention, the heat treatment of the titanium oxide is carried out in a temperature increase step of raising the temperature of the titanium oxide to the target heat treatment temperature, and a calcination step of keeping the temperature as it is after arriving at the target heat treatment temperature to perform calcination of the titanium oxide. The temperature increase step and the calcination step are carried out in an ammonia gas stream.

In this regard, the ammonia gas stream used when the temperature increase step and the calcination step are carried out may be a stream composed solely of an ammonia gas, or may be a mixed stream of an ammonia gas and an inert gas. When a mixed stream of an ammonia gas and an inert gas is employed as the ammonia gas stream, the ammonia concentration in the mixed stream is 10 vol % to 100 vol %. More specifically, at a heat treatment temperature of 600 to 650° C. described later, it is more preferably in the range of 10 vol % to 100 vol %, further preferably in the range of 40 vol % to 100 vol %, and especially preferably in the range of 50 vol % to 100 vol %. At a heat treatment temperature of 650 to 700° C., it is more preferably in the range of 60 vol % to 90 vol %. At a heat treatment temperature of 700 to 800° C., it is more preferably in the range of 10 vol % to 40 vol %, and further preferably in the range of 10 vol % to 30 vol %. The above ranges of the ammonia concentration and the heat treatment temperature are preferable because when calcination is performed in the above ranges, both the electrode potential at 10 μA, and the spontaneous potential in an oxygen gas atmosphere, which are indices of oxygen reduction catalyst activity, can be favorable. The aforedescribed calcination conditions do not apply to the respective oxygen reduction catalysts to be prepared using anatase titanium dioxide in Comparative Example 6, and to be prepared using brookite titanium dioxide in Comparative Example 7 described later.

The temperature increase rate in raising the temperature is 40 to 80° C./min, and preferably 50 to 60° C./min. When the temperature increase rate is higher than the above range, there is a risk that the temperature may overshoot a target heat treatment temperature during temperature increase; and in such a case sintering or particle growth between particles of a resultant oxygen reduction catalyst may occur, to cause change in the crystal structure or decrease in the specific surface area of the catalyst, leading occasionally to insufficient catalyst performance. On the contrary, when the temperature increase rate is lower than the above range, generation of a titanium nitride may occur preferentially over a partial nitridation reaction of a titanium oxide, and it may become difficult to obtain an oxygen reduction catalyst having high catalytic activity.

The heat treatment temperature for performing the aforedescribed calcination (hereinafter “calcination temperature”) is usually 500 to 1000° C., and preferably 600 to 800° C. When the calcination temperature is higher than the above temperature range, sintering or particle growth between particles of a resultant oxygen reduction catalyst may occur, to cause change in the crystal structure or decrease in the specific surface area of the catalyst, leading occasionally to insufficient catalyst performance. Especially, when calcined at a temperature higher than 800° C., the signal intensity ratio N—Ti—N/O—Ti—N becomes large, and the catalyst performance may not be sufficient. On the contrary, when the calcination temperature is lower than the above temperature range, the progress of the nitridation reaction of a titanium oxide is retarded or does not occur, and it tends to become difficult to obtain an oxygen reduction catalyst having high catalytic activity. Meanwhile, the time duration for calcination is usually from 2 to 4 hours, and preferably from 2 to 3 hours. When the calcination time is longer than the time duration upper limit, sintering or particle growth between particles of a resultant oxygen reduction catalyst and may occur, to cause decrease in the specific surface area of the catalyst, leading occasionally to insufficient catalyst performance. On the contrary, when the calcination time is shorter than the above time duration lower limit, the progress of the nitridation reaction of a titanium oxide becomes insufficient, and it tends to become difficult to obtain an oxygen reduction catalyst having high catalytic activity.

### [Sulfuric Acid Treatment]

In a case where an oxygen reduction catalyst of the present invention having the crystal structure of cubic titanium nitride in the surface layer having a thickness of 10 nm of titanium oxide particles when observed with TEM is subjected to a sulfuric acid treatment, the crystal structure of cubic titanium nitride is eliminated. As for the conditions for a sulfuric acid treatment, for example, an oxygen reduction catalyst of the present invention is dispersed ultrasonically in 1 N sulfuric acid, and treated at room temperature for 20 minutes. Since a cubic titanium nitride dissolves in sulfuric acid, the crystal structure of cubic titanium nitride that the catalyst had in the surface layer of titanium oxide particles is not any more observed in an electron diffraction pattern acquired by a TEM observation after performing the sulfuric acid treatment as shown in FIG. 37. In other words, although an oxygen reduction catalyst produced by the aforedescribed method for producing an oxygen reduction catalyst has the crystal structure of cubic titanium nitride in the surface layer having a thickness of 10 nm of the titanium oxide particles constituting the oxygen reduction catalyst, the structure will be lost in an actual operation environment of a fuel cell. The oxygen reduction catalyst of the present invention does not lose its high catalytic activity, even when it loses the crystal structure of cubic titanium nitride.

### [Electrode, Membrane Electrode Assembly, and Fuel Cell]

Although there is no particular restriction on the use of the aforedescribed oxygen reduction catalyst of the present invention, it may be used favorably as an electrode catalyst for a fuel cell, an electrode catalyst for an air cell, etc.

### (Fuel Cell Electrode)

One of the preferred embodiments of the present invention is a fuel cell electrode having a catalyst layer containing the aforedescribed oxygen reduction catalyst of the present invention. In this embodiment, the fuel cell electrode includes an electrode catalyst for a fuel cell composed of the oxygen reduction catalyst of the present invention.

The catalyst layers constituting a fuel cell electrode include an anode catalyst layer and a cathode catalyst layer, and the oxygen reduction catalyst of the present invention may be used for both of them. Since the oxygen reduction catalyst of the present invention has a high oxygen reduction capacity, it is preferably used as the cathode catalyst layer.

In this regard, the catalyst layer preferably further comprises a polymer electrolyte. There is no particular restriction on the polymer electrolyte insofar as it is generally used in a fuel cell catalyst layer. Specific examples thereof include a perfluorocarbon polymer having a sulfo group (for example, NAFION®), a hydrocarbon-based polymer compound having a sulfo group, a polymer compound doped with an inorganic acid such as phosphoric acid, an organic/inorganic hybrid polymer partially substituted with a proton-conducting functional group, and a proton conductor obtained by impregnating a polymer matrix with a phosphoric acid solution or a sulfuric acid solution. Among these, NAFION® is preferable. Examples of a supply source of NAFION® in forming the catalyst layer include a 5% solution of NAFION® (DE 521, E. I. du Pont de Nemours and Company).

If necessary, the catalyst layer may further contain electron-conductive particles composed of carbon, an electroconductive polymer, an electroconductive ceramic, a metal, or an electroconductive inorganic oxide such as tungsten oxide or iridium oxide, etc.

There is no particular restriction on the method for forming the catalyst layer, and a publicly known method may be appropriately employed.

The fuel cell electrode may further have a porous support layer in addition to the catalyst layer.

The porous support layer is a layer that diffuses a gas (hereinafter also referred to as a “gas diffusion layer”). Although the gas diffusion layer may be any material insofar as it has electron conductivity, high gas diffusivity, and high corrosion resistance, a carbon-based porous material, such as carbon paper, and carbon cloth, is generally used.

### (Membrane Electrode Assembly)

A membrane electrode assembly of the present invention is a membrane electrode assembly having a cathode, an anode, and a polymer electrolyte membrane placed between the cathode and the anode, and at least either of the cathode and the anode is the aforedescribed fuel cell electrode of the present invention. In this case, for the electrode in which the fuel cell electrode of the present invention is not employed, a conventionally known fuel cell electrode, such as a fuel cell electrode containing a platinum-based catalyst such as platinum on carbon may be used. Examples of a preferred embodiment of the membrane electrode assembly of the present invention include one in which at least the cathode is the fuel cell electrode of the present invention.

In a case where the fuel cell electrode of the present invention has a gas diffusion layer, this gas diffusion layer is placed on the side opposite to the catalyst layer as viewed from the polymer electrolyte membrane in the membrane electrode assembly of the present invention.

As the polymer electrolyte membrane, for example, an electrolyte membrane using a perfluorosulfonic acid, or a hydrocarbon-based electrolyte membrane is generally used. Also a membrane in which a polymer microporous membrane is impregnated with a liquid electrolyte, or a membrane in which a porous material is filled with a polymer electrolyte may be used.

The membrane electrode assembly of the present invention can be appropriately formed using a conventionally known method.

### (Fuel Cell)

A fuel cell of the present invention comprises the aforedescribed membrane electrode assembly. In this regard, in a typical embodiment of the present invention, the fuel cell of the present invention further comprises two current collectors in a mode that the two current collectors sandwich the membrane electrode assembly. The current collector may be one which is conventionally known and which is generally employed for a fuel cell.

### EXAMPLES

### Example 1

### (1) Preparation of Oxygen Reduction Catalyst

An oxygen reduction catalyst (1) was obtained by weighing 0.2 g of a rutile titanium dioxide powder (SUPER-TITANIA® grade G-1, manufactured by Showa Denko K.K); raising its temperature using a quartz tube furnace in a mixed stream of an ammonia gas (gas flow rate of 20 mL/min) and a nitrogen gas (gas flow rate of 180 mL/min) (ammonia gas: 10 vol %) from room temperature to 600° C. at a temperature increase rate of 50° C./min; and performing calcination at 600° C. for 3 hours.

### (2) Electrochemical Measurement

### (Preparation of Catalyst Electrode)

The fuel cell electrode (hereinafter, “catalyst electrode”) comprising an oxygen reduction catalyst was prepared as follows. A liquid containing 15 mg of the obtained oxygen reduction catalyst (1), 1.0 mL of 2-propanol, 1.0 mL of ion exchanged water, 62 μL of NAFION® (5% aqueous solution of NAFION, manufactured by Wako Pure Chemical Industries, Ltd.) was stirred by irradiation with ultrasonic waves, and mixed to a suspension. The mixture of 20 μL was applied to a glassy carbon electrode (diameter: 5.2 mm, manufactured by Tokai Carbon Co., Ltd.), dried at 70° C. for 1 hour, to give a catalyst electrode for measuring the oxygen reduction catalyst activity.

### (Measurement of Oxygen Reduction Catalyst Activity)

An electrochemical evaluation of the oxygen reduction active catalytic capacity of the oxygen reduction catalyst (1) was performed as follows. The catalyst electrode prepared in the above “preparation of catalyst electrode” was polarized at a potential scanning rate of 5 mV/sec in a 0.5 mol/dm³ aqueous solution of sulfuric acid at 30° C. and the current-potential curve was measured in each of an oxygen gas atmosphere and a nitrogen gas atmosphere. Also, a spontaneous potential (open circuit potential) in a non-polarized state in an oxygen gas atmosphere was obtained. In doing so, a reversible hydrogen electrode in an aqueous solution of sulfuric acid with the same concentration was used as a reference electrode.

From the difference between the reduction current curve in the oxygen gas atmosphere and the reduction current curve in the nitrogen gas atmosphere among the current-potential curves obtained in the above electrochemical evaluation, an electrode potential at 10 μA from the current-potential curve (hereinafter also referred to as electrode potential) was obtained. Further, the oxygen reduction catalytic capacity of the oxygen reduction catalyst (1) was evaluated using the electrode potential and the spontaneous potential. These electrode potentials and spontaneous potentials are shown in Table 1A. The spontaneous potential represents the quality of the oxygen reduction catalyst activity, and the electrode potential at 10 μA represents the quantity of the oxygen reduction catalyst activity.

### (3) Powder X-Ray Diffraction Measurement (Rutile Titanium Dioxide Crystal and Rutile Content Ratio)

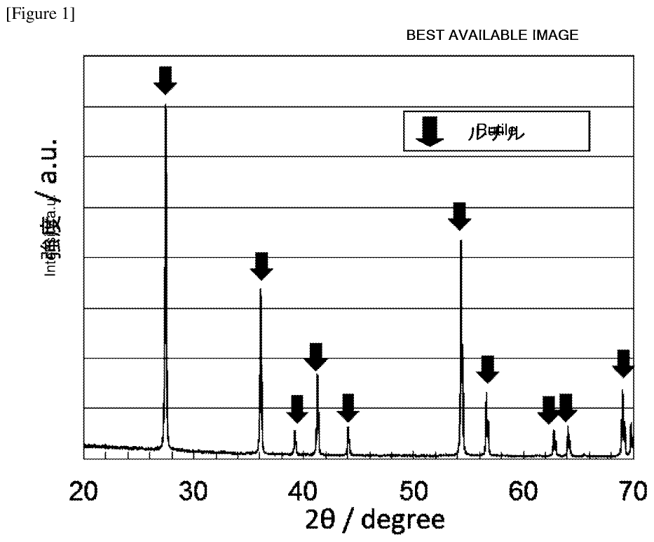

A powder X-ray diffraction measurement of a sample was performed using a powder X-ray diffractometer PANalytical MPD (manufactured by Spectris plc). As for the X-ray diffraction measurement conditions, a measurement was performed in the range of the diffraction angle of 2θ=10 to 90° using a Cu-Kα ray (output 45 kV, 40 mA), to give an X-ray diffraction spectrum of the oxygen reduction catalyst (1). The X-ray diffraction spectrum obtained by performing the powder X-ray diffraction measurement is shown in FIG. 1.

The height of the peak with the strongest diffraction intensity among the peaks attributable to a rutile titanium dioxide crystal (Hr), the height of the peak with the strongest diffraction intensity among the peaks attributable to an anatase titanium dioxide crystal (Ha), the height of the peak with the strongest diffraction intensity among the peaks attributable to a brookite titanium dioxide crystal (Hb), and the height of the peak with the strongest diffraction intensity among the peaks attributable to a cubic titanium nitride (Hc) were determined and the content of the rutile titanium dioxide (rutile content ratio) in the oxygen reduction catalyst (1) was determined according to the following expression. In this regard, the respective heights of the peaks with the strongest diffraction intensity were obtained after subtracting an arithmetic mean of the signal intensity in the range of 50 to 52° where a diffraction peak was not detected as the baseline.

Rutile content ratio(mol %)=[Hr/(Hr+Ha+Hb+Hc))]×100

It was confirmed that the oxygen reduction catalyst (1) had a rutile content ratio of 90 mol % or more, and had the crystal structure of rutile titanium dioxide.

### (4) Rietveld Analysis

The lattice constants of the obtained oxygen reduction catalyst (1) were determined by a Rietveld analysis of the powder X-ray diffraction spectrum. The Rietveld analysis was performed with the PANalytical HighScore+Ver. 3.0d program. The lattice constants of the oxygen reduction catalyst (1) were obtained by identifying the X-ray diffraction pattern using a Pseudo-Voigt function and the crystal information of reference code 98-001-6636 as the standard rutile titanium dioxide so as to refine the parameters related to the crystal structure. The lattice constants a, b, and c of the rutile titanium dioxide of the oxygen reduction catalyst (1) determined by the Rietveld analysis are shown in Table 1A.

The lattice constants a, b, and c of the standard rutile titanium dioxide are 4.594 Å, 4.594 Å, and 2.959 Å, respectively. All the differences of the lattice constants a, b, and c of the oxygen reduction catalyst (1) from those of the standard rutile titanium dioxide were 0.005 Å or less.

### (5) X-Ray Photoelectron Spectroscopic Analysis

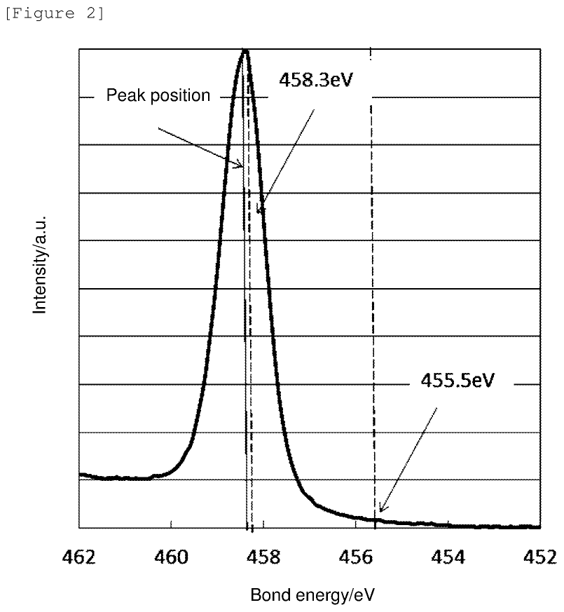

An X-ray photoelectron spectroscopic analysis of the oxygen reduction catalyst (1) was performed using an X-ray photoelectron spectrometer Quantera II (manufactured by ULVAC-PHI, Inc.). The sample was embedded in metal indium for immobilization. A measurement was performed under the conditions of X-ray: Al monochromatic, 25 W, 15 kV, measurement area: 400×400 μm², electron/ion neutralization gun: ON, and photoelectron take-off angle: 45°; and correction of the bond energy was performed with respect to the peak position of the peak derived from a contaminated hydrocarbon chain in the C1s XPS spectrum defined as 284.6 eV. The obtained Ti2p XPS spectrum is shown in FIG. 2. The signal intensity at 455.5 eV reflects the bond of N—Ti—N, which means formation of a titanium nitride, and a state of low oxygen reduction capacity. The signal intensity at 458.3 eV reflects the bond of O—Ti—N for which 0 in O—Ti—O has been replaced with N, namely it represents a state of high oxygen reduction capacity where part of oxygen atoms in a titanium dioxide has been replaced with nitrogen atoms. The signal intensity ratio N—Ti—N/O—Ti—N is also shown in Table 1A which ratio was determined using the intensity value of the Ti2p XPS spectrum at 455.5 eV as the intensity of N—Ti—N, and the intensity value at 458.3 eV as the intensity of O—Ti—N, after subtracting an arithmetic mean value of the signal intensity in the range of 450 to 452 eV where a peak derived from Ti2p was not observed as the baseline.

In a case in which the peak position in terms of bond energy of a peak located in the range of 458.0 to 459.5 eV is shifted toward the lower energy side compared to a bond energy of 459.0 eV attributable to O—Ti—O in rutile titanium dioxide not having an oxygen defect, it can be determined that an oxygen atom in the titanium dioxide has been replaced with a nitrogen atom to have an oxygen defect. Since the oxygen reduction catalyst (1) has the crystal structure of rutile titanium dioxide, its peak position is shifted to a lower energy side compared to the bond energy, 459.0 eV, of O—Ti—O in rutile titanium dioxide not having an oxygen defect, and the nitrogen element content is 2.0 mass % or less, it can be determined that it has an oxygen defect formed by replacement of an oxygen atom in rutile titanium dioxide with a nitrogen atom.

### (6) Elemental Analysis

A measurement was performed after weighing 10 mg of the oxygen reduction catalyst (1) into a nickel capsule, by an inert gas fusion-thermal conductivity method using a TC-600 manufactured by LECO Corporation with an output of 1500 W to 5000 W (70 Wup/sec). The nitrogen element content (mass %) thus obtained is shown in Table 1A.

### (7) Transmission Electron Microscope (TEM) Observation

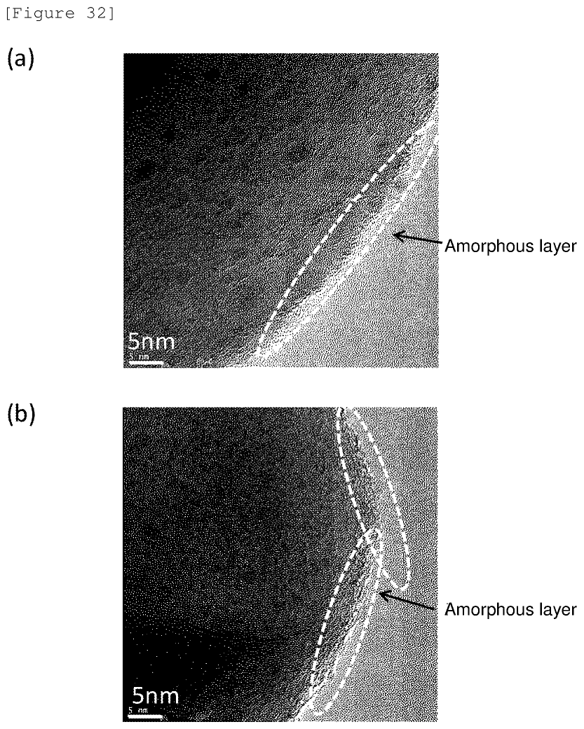

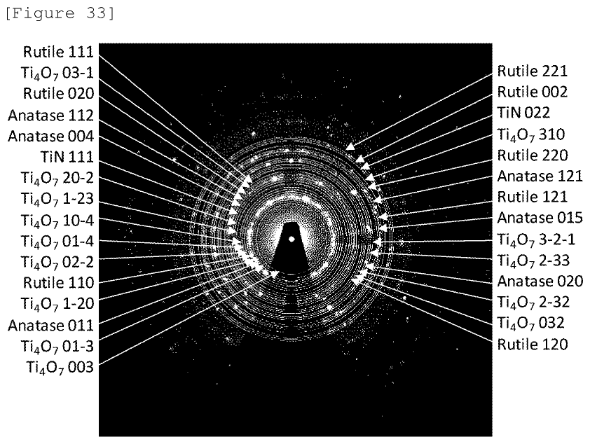

The oxygen reduction catalyst (1) was highly dispersed in an alcohol solvent using ultrasonic waves, and then dispersed over a microgrid for a TEM observation, to give a sample for a TEM observation. For observation, a bright field image was photographed using a Tecnai G2F20 manufactured by FEI Company under an acceleration voltage condition of 200 kV. TEM photographs of the oxygen reduction catalyst (1) are shown in FIGS. 32 (a) and (b). It was confirmed that the catalyst has an amorphous layer in the surface layer having a thickness of 10 nm of a titanium oxide particle.

In addition, an electron diffraction pattern was acquired from a region having a diameter of 200 nm of the oxygen reduction catalyst (1) using a selector aperture. The obtained electron diffraction pattern is shown in FIG. 31. It was confirmed that it had the crystal structures of titanium oxide Ti₄O₇ and cubic titanium nitride together with the rutile crystal structure.

### Example 2

### (1) Preparation of Oxygen Reduction Catalyst

The oxygen reduction catalyst (2) was obtained by performing temperature increase and calcination in the same manner as in Example 1 except that the flow rates of an ammonia gas and a nitrogen gas were changed to 60 mL/min and 140 mL/min (ammonia gas: 30 vol %), respectively.

### (2) Electrochemical Measurement, Powder X-Ray Diffraction Measurement, Rietveld Analysis, X-Ray Photoelectron Spectroscopic Analysis, and Elemental Analysis

The electrochemical measurement, powder X-ray diffraction measurement, Rietveld analysis, X-ray photoelectron spectroscopic analysis, and elemental analysis of the oxygen reduction catalyst (2) were performed in the same manner as in Example 1.

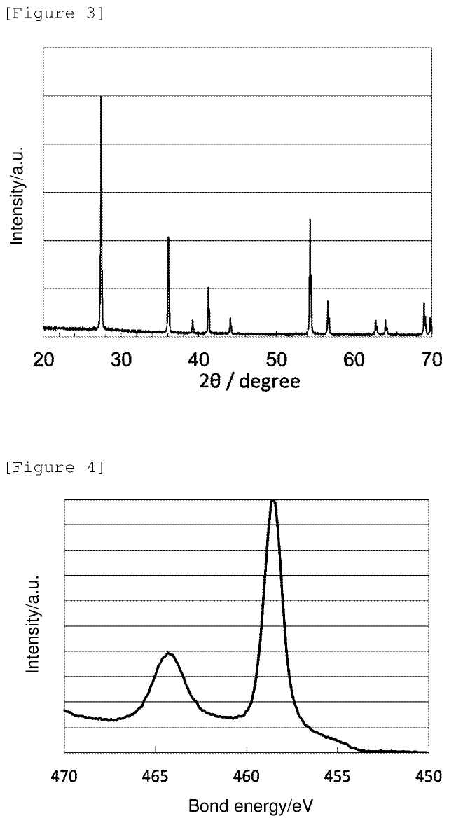

The obtained X-ray diffraction spectrum and Ti2p XPS spectrum are shown in FIG. 3 and FIG. 4, respectively.

Also, the lattice constants a, b, and c of the oxygen reduction catalyst (2) determined by a Rietveld analysis, the nitrogen element content (mass %) obtained by an elemental analysis, the signal intensity ratio N—Ti—N/O—Ti—N determined by an X-ray photoelectron spectroscopic analysis, the peak position determined as a bond energy at which the highest intensity was obtained in 458.0 to 459.5 eV, and the electrode potential and the spontaneous potential determined by an electrochemical measurement are shown together in Table 1A.

All the differences of the lattice constants a, b, and c of the oxygen reduction catalyst (2) from those of the standard rutile titanium dioxide were 0.005 Å or less.

Since the oxygen reduction catalyst (2) has a rutile content ratio of 90 mol % or more, and has the crystal structure of rutile titanium dioxide, its peak position is shifted to a lower energy side compared to the bond energy, 459.0 eV, of titanium in rutile titanium dioxide not having an oxygen defect (namely, bond energy of O—Ti—O), and the nitrogen element content is 2.0 mass % or less, it can be determined that it has an oxygen defect formed by replacement of an oxygen atom in rutile titanium dioxide with a nitrogen atom.

### Example 3

### (1) Preparation of Oxygen Reduction Catalyst

The oxygen reduction catalyst (3) was obtained by performing temperature increase and calcination in the same manner as in Example 1 except that the flow rates of an ammonia gas and a nitrogen gas were both changed to 100 mL/min (ammonia gas: 50 vol %).

### (2) Electrochemical Measurement, Powder X-Ray Diffraction Measurement, Rietveld Analysis, X-Ray Photoelectron Spectroscopic Analysis, and Elemental Analysis

The electrochemical measurement, powder X-ray diffraction measurement, Rietveld analysis, X-ray photoelectron spectroscopic analysis, and elemental analysis of the oxygen reduction catalyst (3) were performed in the same manner as in Example 1.

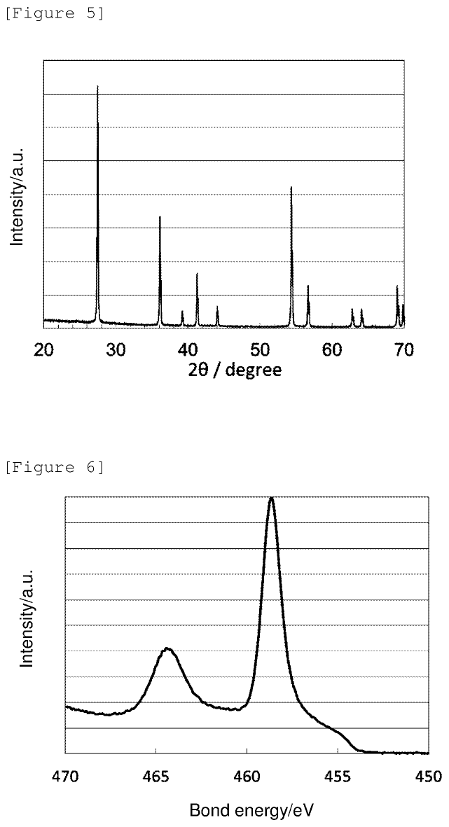

The obtained X-ray diffraction spectrum and Ti2p XPS spectrum are shown in FIG. 5 and FIG. 6, respectively.

Also, the lattice constants a, b, and c of rutile titanium dioxide determined by a Rietveld analysis, the nitrogen element content (mass %) obtained by an elemental analysis, the signal intensity ratio N—Ti—N/O—Ti—N determined by an X-ray photoelectron spectroscopic analysis, the peak position determined as a bond energy at which the highest intensity was obtained in 458.0 to 459.5 eV, and the electrode potential and the spontaneous potential determined by an electrochemical measurement are shown together in Table 1A.

All the differences of the lattice constants a, b, and c of the oxygen reduction catalyst (3) from those of the standard rutile titanium dioxide were 0.005 Å or less.

Since the oxygen reduction catalyst (3) has a rutile content ratio of 90 mol % or more, and has the crystal structure of rutile titanium dioxide, its peak position is shifted to a lower energy side compared to the bond energy, 459.0 eV, of titanium in rutile titanium dioxide not having an oxygen defect (namely, bond energy of O—Ti—O), and the nitrogen element content is 2.0 mass % or less, it has an oxygen defect formed by replacement of an oxygen atom in rutile titanium dioxide with a nitrogen atom.

### Example 4

### (1) Preparation of Oxygen Reduction Catalyst

The oxygen reduction catalyst (4) was obtained by performing temperature increase and calcination in the same manner as in Example 1 except that the flow rates of an ammonia gas and a nitrogen gas were changed to 140 mL/min and 60 mL/min (ammonia gas: 70 vol %), respectively.

### (2) Electrochemical Measurement, Powder X-Ray Diffraction Measurement, Rietveld Analysis, X-Ray Photoelectron Spectroscopic Analysis, and Elemental Analysis

The electrochemical measurement, powder X-ray diffraction measurement, Rietveld analysis, X-ray photoelectron spectroscopic analysis, and elemental analysis of the oxygen reduction catalyst (4) were performed in the same manner as in Example 1.

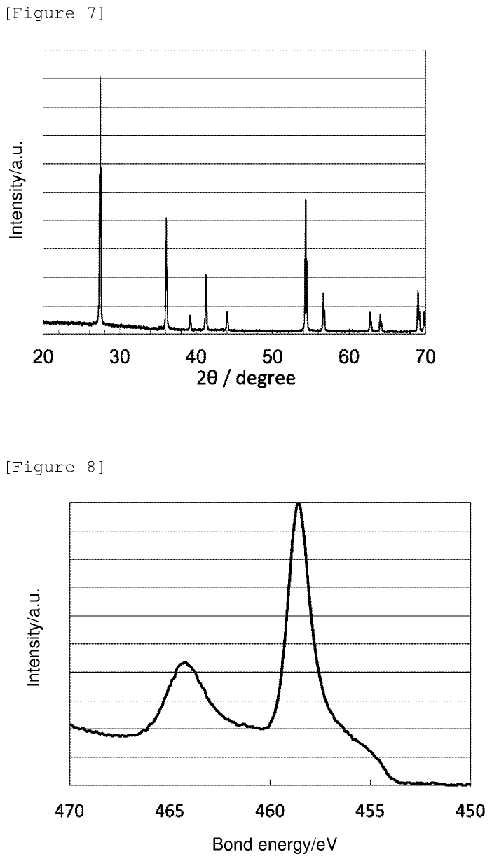

The obtained X-ray diffraction spectrum and Ti2p XPS spectrum are shown in FIG. 7 and FIG. 8, respectively.

Also, the lattice constants a, b, and c of the oxygen reduction catalyst (4) determined by a Rietveld analysis, the nitrogen element content (mass %) obtained by an elemental analysis, the signal intensity ratio N—Ti—N/O—Ti—N determined by an X-ray photoelectron spectroscopic analysis, the peak position determined as a bond energy at which the highest intensity was obtained in 458.0 to 459.5 eV, and the electrode potential and the spontaneous potential determined by an electrochemical measurement are shown together in Table 1A.

All the differences of the lattice constants a, b, and c of the oxygen reduction catalyst (4) from those of the standard rutile titanium dioxide were 0.005 Å or less.

Since the oxygen reduction catalyst (4) has a rutile content ratio of 90 mol % or more, and has the crystal structure of rutile titanium dioxide, its peak position is shifted to a lower energy side compared to the bond energy, 459.0 eV, of titanium in rutile titanium dioxide not having an oxygen defect (namely, bond energy of O—Ti—O), and the nitrogen element content is 2.0 mass % or less, it has an oxygen defect formed by replacement of an oxygen atom in rutile titanium dioxide with a nitrogen atom.

### Example 5

### (1) Preparation of Oxygen Reduction Catalyst

The oxygen reduction catalyst (5) was obtained by performing temperature increase and calcination in the same manner as in Example 1 except that the mixed stream of an ammonia gas and a nitrogen gas was changed to a stream of an ammonia gas, and the flow rate of the ammonia gas was set at 200 mL/min (ammonia gas: 100 vol %).

### (2) Electrochemical Measurement, Powder X-Ray Diffraction Measurement, Rietveld Analysis, X-Ray Photoelectron Spectroscopic Analysis, and Elemental Analysis

The electrochemical measurement, powder X-ray diffraction measurement, Rietveld analysis, X-ray photoelectron spectroscopic analysis, and elemental analysis of the oxygen reduction catalyst (5) were performed in the same manner as in Example 1.

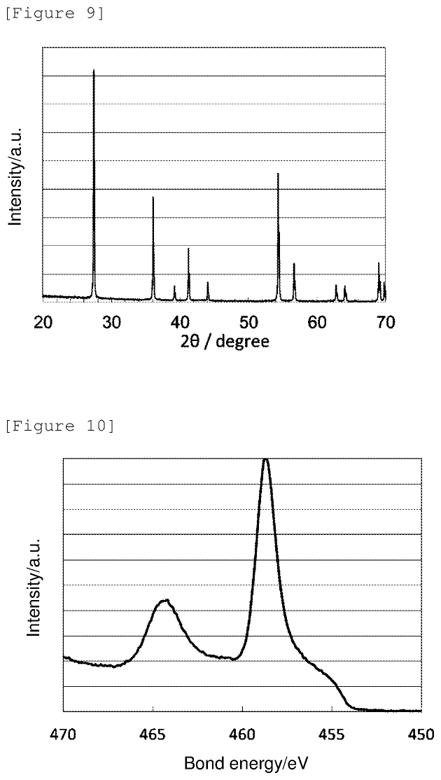

The obtained X-ray diffraction spectrum and Ti2p XPS spectrum are shown in FIG. 9 and FIG. 10, respectively.

Also, the lattice constants a, b, and c of the oxygen reduction catalyst (5) determined by a Rietveld analysis, the nitrogen element content (mass %) obtained by an elemental analysis, the signal intensity ratio N—Ti—N/O—Ti—N determined by an X-ray photoelectron spectroscopic analysis, the peak position determined as a bond energy at which the highest intensity was obtained in 458.0 to 459.5 eV, and the electrode potential and the spontaneous potential determined by an electrochemical measurement are shown together in Table 1A.

All the differences of the lattice constants a, b, and c of the oxygen reduction catalyst (5) from those of the standard rutile titanium dioxide were 0.005 Å or less.

Since the oxygen reduction catalyst (5) has a rutile content ratio of 90 mol % or more, and has the crystal structure of rutile titanium dioxide, its peak position is shifted to a lower energy side compared to the bond energy, 459.0 eV, of titanium in rutile titanium dioxide not having an oxygen defect (namely, bond energy of O—Ti—O), and the nitrogen element content is 2.0 mass % or less, it has an oxygen defect formed by replacement of an oxygen atom in rutile titanium dioxide with a nitrogen atom.

### (3) Transmission Electron Microscope (TEM) Observation

A bright field image of the oxygen reduction catalyst (5) was photographed in the same manner as in Example 1. The TEM photographs of the oxygen reduction catalyst (5) are shown in FIGS. 30 (a) and (b). It was confirmed that the catalyst has an amorphous layer in the surface layer having a thickness of 10 nm of a titanium oxide particle.

In addition, an electron diffraction pattern was acquired from a region having a diameter of 200 nm using a selector aperture. The obtained electron diffraction pattern is shown in FIG. 29. It was confirmed that it had the crystal structures of titanium oxide Ti₄O₇ and cubic titanium nitride together with the rutile crystal structure.

(4) Transmission Electron Microscope (TEM) Observation of Oxygen Reduction Catalyst (5) Treated with Sulfuric Acid

When a sulfuric acid treatment is performed on the oxygen reduction catalyst of the present invention, the crystal structure of cubic titanium nitride that may exist in the surface layer of a titanium oxide particle is eliminated. Based on this, a TEM observation was also performed on a sample obtained by performing a sulfuric acid treatment on the oxygen reduction catalyst (5) according to the following procedures.

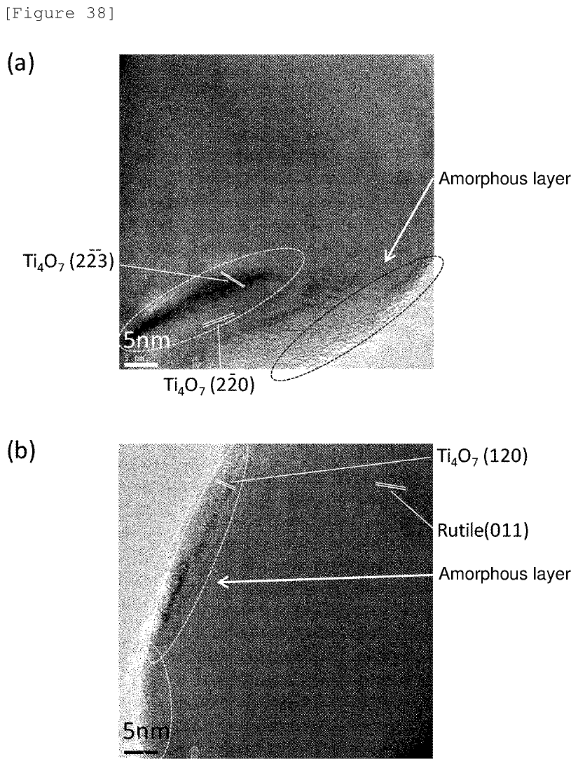

The oxygen reduction catalyst (5) was dispersed in 1 N sulfuric acid using ultrasonic waves and treated at room temperature for 20 minutes. With respect to a sample obtained through such a sulfuric acid treatment (hereinafter, “sulfuric acid-treated oxygen reduction catalyst (5)”), a bright field image was photographed in the same manner as in Example 1. The TEM photographs of the sulfuric acid-treated oxygen reduction catalyst (5) are shown in FIGS. 38 (a) and (b). It was confirmed that the catalyst had an amorphous layer in the surface layer of a titanium oxide particle, and further had the crystal structure of titanium oxide of Ti₄O₇.

In addition, for the sulfuric acid-treated oxygen reduction catalyst (5), an electron diffraction pattern was acquired from a region having a diameter of 200 nm using a selector aperture. The obtained electron diffraction pattern is shown in FIG. 37. It was confirmed that it had the crystal structure of titanium oxide Ti₄O₇ together with the rutile crystal structure. The crystal structure of cubic titanium nitride was not recognized to confirm that it was lost by the sulfuric acid treatment.

### Example 6

### (1) Preparation of Oxygen Reduction Catalyst

The oxygen reduction catalyst (6) was obtained by performing temperature increase and calcination in the same manner as in Example 1 except that the end-point temperature at the temperature increase and the temperature for performing calcination were changed to 700° C.

### (2) Electrochemical Measurement, Powder X-Ray Diffraction Measurement, Rietveld Analysis, X-Ray Photoelectron Spectroscopic Analysis, and Elemental Analysis

The electrochemical measurement, powder X-ray diffraction measurement, Rietveld analysis, X-ray photoelectron spectroscopic analysis, and elemental analysis of the oxygen reduction catalyst (6) were performed in the same manner as in Example 1.

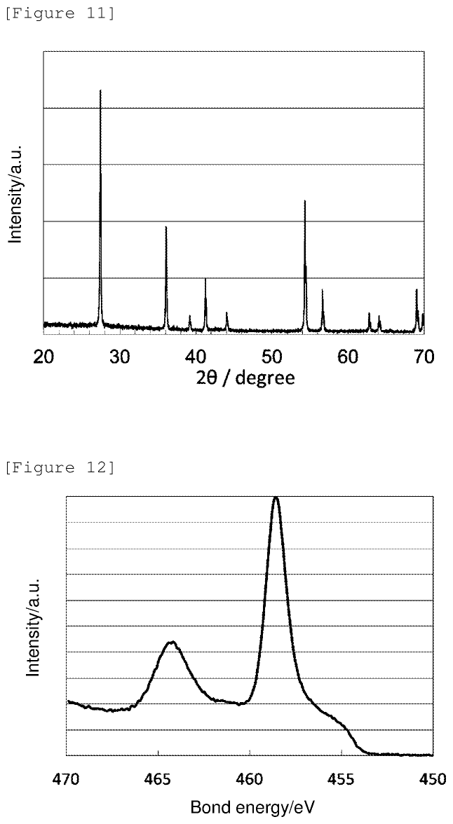

The obtained X-ray diffraction spectrum and Ti2p XPS spectrum are shown in FIG. 11 and FIG. 12, respectively.

Also, the lattice constants a, b, and c of the oxygen reduction catalyst (6) determined by a Rietveld analysis, the nitrogen element content (mass %) obtained by an elemental analysis, the signal intensity ratio N—Ti—N/O—Ti—N determined by an X-ray photoelectron spectroscopic analysis, the peak position determined as a bond energy at which the highest intensity was obtained in 458.0 to 459.5 eV, and the electrode potential and the spontaneous potential determined by an electrochemical measurement are shown together in Table 1A.

All the differences of the lattice constants a, b, and c of the oxygen reduction catalyst (6) from those of the standard rutile titanium dioxide were 0.005 Å or less.

Since the oxygen reduction catalyst (6) has a rutile content ratio of 90 mol % or more, and has the crystal structure of rutile titanium dioxide, its peak position is shifted to a lower energy side compared to the bond energy, 459.0 eV, of titanium in rutile titanium dioxide not having an oxygen defect (namely, bond energy of O—Ti—O), and the nitrogen element content is 2.0 mass % or less, it has an oxygen defect formed by replacement of an oxygen atom in rutile titanium dioxide with a nitrogen atom.

### Example 7

### (1) Preparation of Oxygen Reduction Catalyst

The oxygen reduction catalyst (7) was obtained by performing temperature increase and calcination in the same manner as in Example 1 except that the flow rates of an ammonia gas and a nitrogen gas are changed to 60 mL/min and 140 mL/min (ammonia gas: 30 vol %), respectively, and the end-point temperature at the temperature increase and the temperature for performing calcination were changed to 700° C.

### (2) Electrochemical Measurement, Powder X-Ray Diffraction Measurement, Rietveld Analysis, X-Ray Photoelectron Spectroscopic Analysis, and Elemental Analysis

The electrochemical measurement, powder X-ray diffraction measurement, Rietveld analysis, X-ray photoelectron spectroscopic analysis, and elemental analysis of the oxygen reduction catalyst (7) were performed in the same manner as in Example 1.

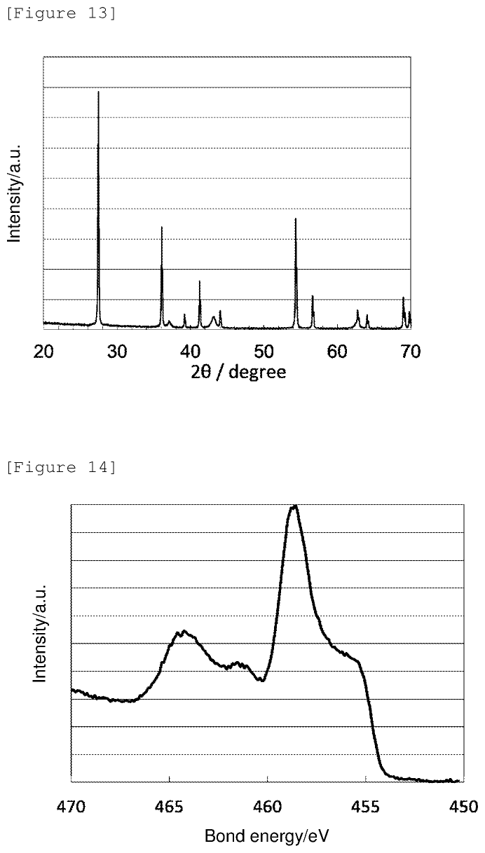

The obtained X-ray diffraction spectrum and Ti2p XPS spectrum are shown in FIG. 13 and FIG. 14, respectively.

Also, the lattice constants a, b, and c of the oxygen reduction catalyst (7) determined by a Rietveld analysis, the nitrogen element content (mass %) obtained by an elemental analysis, the signal intensity ratio N—Ti—N/O—Ti—N determined by an X-ray photoelectron spectroscopic analysis, the peak position determined as a bond energy at which the highest intensity was obtained in 458.0 to 459.5 eV, and the electrode potential and the spontaneous potential determined by an electrochemical measurement are shown together in Table 1A.

All the differences of the lattice constants a, b, and c of the oxygen reduction catalyst (7) from those of the standard rutile titanium dioxide were 0.005 Å or less.

Since the oxygen reduction catalyst (7) has a rutile content ratio of 90 mol % or more, and has the crystal structure of rutile titanium dioxide, its peak position is shifted to a lower energy side compared to the bond energy, 459.0 eV, of titanium in rutile titanium dioxide not having an oxygen defect (namely, bond energy of O—Ti—O), and the nitrogen element content is 2.0 mass % or less, it has an oxygen defect formed by replacement of an oxygen atom in rutile titanium dioxide with a nitrogen atom.

### Comparative Example 1

### (1) Preparation of Oxygen Reduction Catalyst

The oxygen reduction catalyst (c1) was obtained by performing temperature increase and calcination in the same manner as in Example 1 except that the flow rates of an ammonia gas and a nitrogen gas were both changed to 100 mL/min (ammonia gas: 50 vol %), and the end-point temperature at the temperature increase and the temperature for performing calcination were changed to 700° C.

### (2) Electrochemical Measurement, Powder X-Ray Diffraction Measurement, Rietveld Analysis, X-Ray Photoelectron Spectroscopic Analysis, and Elemental Analysis

The electrochemical measurement, powder X-ray diffraction measurement, Rietveld analysis, X-ray photoelectron spectroscopic analysis, and elemental analysis of the oxygen reduction catalyst (c1) were performed in the same manner as in Example 1.

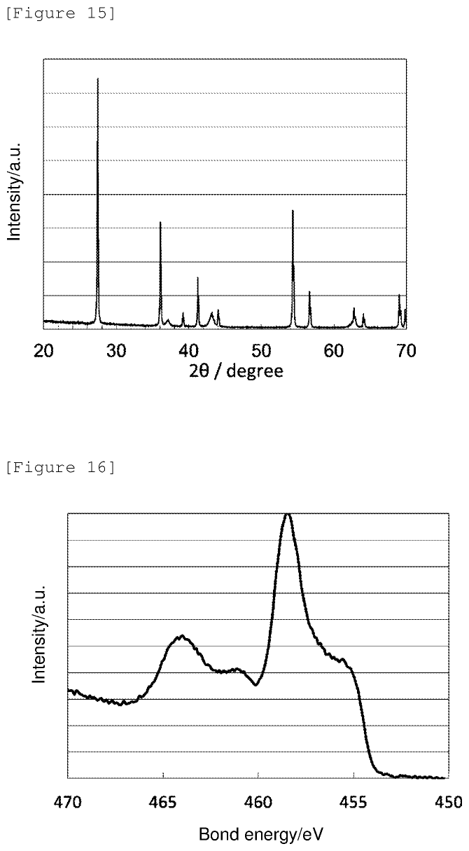

The obtained X-ray diffraction spectrum and Ti2p XPS spectrum are shown in FIG. 15 and FIG. 16, respectively. The oxygen reduction catalyst (c1) had a rutile content ratio of 90 mol % or more, and had the crystal structure of rutile titanium dioxide.

Also, the lattice constants a, b, and c of the oxygen reduction catalyst (c1) determined by a Rietveld analysis, the nitrogen element content (mass %) obtained by an elemental analysis, the signal intensity ratio N—Ti—N/O—Ti—N determined by an X-ray photoelectron spectroscopic analysis, the peak position determined as a bond energy at which the highest intensity was obtained in 458.0 to 459.5 eV, and the electrode potential and the spontaneous potential determined by an electrochemical measurement are shown together in Table 1B.

### Comparative Example 2

### (1) Preparation of Oxygen Reduction Catalyst

The oxygen reduction catalyst (c2) was obtained by performing temperature increase and calcination in the same manner as in Example 1 except that the mixed stream of an ammonia gas and a nitrogen gas was changed to a stream of an ammonia gas, and the flow rate of the ammonia gas was set at 200 mL/min (ammonia gas: 100 vol %), and the end-point temperature at the temperature increase and the temperature for performing calcination were changed to 700° C.

### (2) Electrochemical Measurement, Powder X-Ray Diffraction Measurement, Rietveld Analysis, X-Ray Photoelectron Spectroscopic Analysis, and Elemental Analysis

The electrochemical measurement, powder X-ray diffraction measurement, Rietveld analysis, X-ray photoelectron spectroscopic analysis, and elemental analysis of the oxygen reduction catalyst (c2) were performed in the same manner as in Example 1.

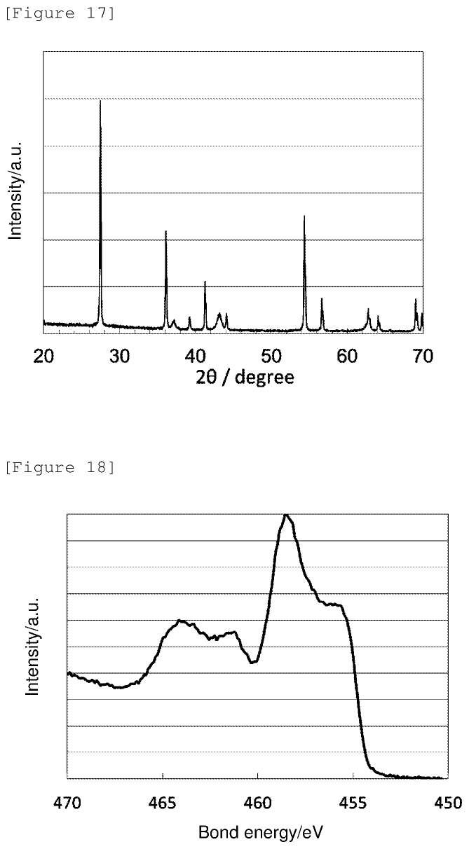

The obtained X-ray diffraction spectrum and Ti2p XPS spectrum are shown in FIG. 17 and FIG. 18, respectively. The oxygen reduction catalyst (c2) had a rutile content ratio of 90 mol % or more, and had the crystal structure of rutile titanium dioxide.

Also, the lattice constants a, b, and c of the oxygen reduction catalyst (c2) determined by a Rietveld analysis, the nitrogen element content (mass %) obtained by an elemental analysis, the signal intensity ratio N—Ti—N/O—Ti—N determined by an X-ray photoelectron spectroscopic analysis, the peak position determined as a bond energy at which the highest intensity was obtained in 458.0 to 459.5 eV, and the electrode potential and the spontaneous potential determined by an electrochemical measurement are shown together in Table 1B.

### Comparative Example 3

### (1) Preparation of Oxygen Reduction Catalyst

The oxygen reduction catalyst (c3) was obtained by performing temperature increase and calcination in the same manner as in Example 1 except that the mixed stream of an ammonia gas and a nitrogen gas was changed to a stream of an ammonia gas, and the flow rate of the ammonia gas was set at 200 mL/min (ammonia gas: 100 vol %), and the end-point temperature at the temperature increase and the temperature for performing calcination were changed to 800° C.

### (2) Electrochemical Measurement, Powder X-Ray Diffraction Measurement, Rietveld Analysis, X-Ray Photoelectron Spectroscopic Analysis, and Elemental Analysis

The electrochemical measurement, powder X-ray diffraction measurement, Rietveld analysis, X-ray photoelectron spectroscopic analysis, and elemental analysis of the oxygen reduction catalyst (c3) were performed in the same manner as in Example 1.

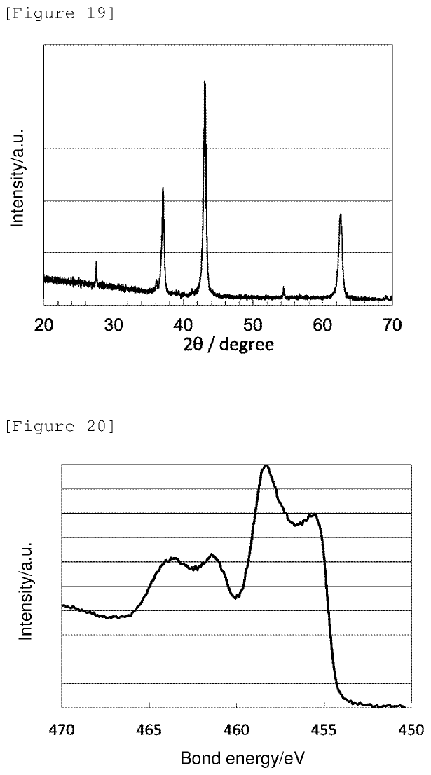

The obtained X-ray diffraction spectrum and Ti2p XPS spectrum are shown in FIG. 19 and FIG. 20, respectively. The oxygen reduction catalyst (c3) had a rutile content ratio of 14 mol %, and did not have the crystal structure of rutile titanium dioxide.

Also, the lattice constants a, b, and c of the oxygen reduction catalyst (c3) determined by a Rietveld analysis, the nitrogen element content (mass %) obtained by an elemental analysis, the signal intensity ratio N—Ti—N/O—Ti—N determined by an X-ray photoelectron spectroscopic analysis, the peak position determined as a bond energy at which the highest intensity was obtained in 458.0 to 459.5 eV, and the electrode potential and the spontaneous potential determined by an electrochemical measurement are shown together in Table 1B.

### Comparative Example 4

### (1) Preparation of Oxygen Reduction Catalyst

The oxygen reduction catalyst (c4) was obtained by performing temperature increase and calcination in the same manner as in Example 1 except that the mixed stream of an ammonia gas and a nitrogen gas was changed to a stream of an ammonia gas, and the flow rate of the ammonia gas was set at 200 mL/min (ammonia gas: 100 vol %), and the end-point temperature at the temperature increase and the temperature for performing calcination were changed to 900° C.

### (2) Electrochemical Measurement, Powder X-Ray Diffraction Measurement, Rietveld Analysis, X-Ray Photoelectron Spectroscopic Analysis, and Elemental Analysis

The electrochemical measurement, powder X-ray diffraction measurement, Rietveld analysis, X-ray photoelectron spectroscopic analysis, and elemental analysis of the oxygen reduction catalyst (c4) were performed in the same manner as in Example 1.

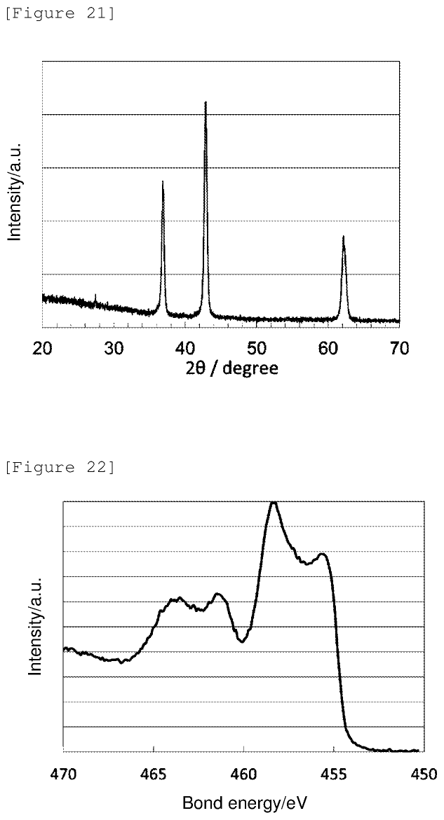

The obtained X-ray diffraction spectrum and Ti2p XPS spectrum are shown in FIG. 21 and FIG. 22, respectively. The oxygen reduction catalyst (c4) had a rutile content ratio of 10 mol %, and did not have the crystal structure of rutile titanium dioxide.

Also, the nitrogen element content (mass %) obtained by an elemental analysis of the oxygen reduction catalyst (c4), the signal intensity ratio N—Ti—N/O—Ti—N determined by an X-ray photoelectron spectroscopic analysis, the peak position determined as a bond energy at which the highest intensity was obtained in 458.0 to 459.5 eV, and the electrode potential and the spontaneous potential determined by an electrochemical measurement are shown together in Table 1B.

### Comparative Example 5

### (1) Preparation of Oxygen Reduction Catalyst

A rutile titanium dioxide powder (SUPER-TITANIA® grade G-1, manufactured by Showa Denko K.K.), was used as it was without performing the calcination treatment of Example 1 as an oxygen reduction catalyst (c5).

### (2) Electrochemical Measurement, Powder X-Ray Diffraction Measurement, Rietveld Analysis, X-Ray Photoelectron Spectroscopic Analysis, and Elemental Analysis

The electrochemical measurement, powder X-ray diffraction measurement, Rietveld analysis, X-ray photoelectron spectroscopic analysis, and elemental analysis of the oxygen reduction catalyst (c5) were performed in the same manner as in Example 1.

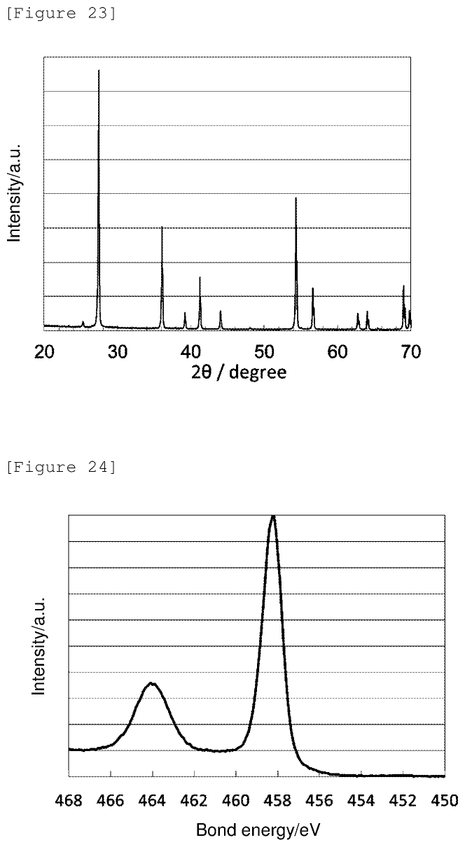

The obtained X-ray diffraction spectrum and Ti2p XPS spectrum are shown in FIG. 23 and FIG. 24, respectively.

Also, the lattice constants a, b, and c of the oxygen reduction catalyst (c5) determined by a Rietveld analysis, the nitrogen element content (mass %) obtained by an elemental analysis, the signal intensity ratio N—Ti—N/O—Ti—N determined by an X-ray photoelectron spectroscopic analysis, the peak position determined as a bond energy at which the highest intensity was obtained in 458.0 to 459.5 eV, and the electrode potential and the spontaneous potential determined by an electrochemical measurement are shown together in Table 1B.

### Comparative Example 6

### (1) Preparation of Oxygen Reduction Catalyst

The oxygen reduction catalyst (c6) was obtained by performing temperature increase and calcination in the same manner as in Example 1 except that the rutile titanium dioxide powder was changed to an anatase titanium dioxide powder (SUPER-TITANIA® grade F-6, manufactured by Showa Denko K.K.), and the end-point temperature at the temperature increase and the temperature for performing calcination were changed to 500° C.

### (2) Electrochemical Measurement, Powder X-Ray Diffraction Measurement, Rietveld Analysis, X-Ray Photoelectron Spectroscopic Analysis, and Elemental Analysis

The electrochemical measurement, powder X-ray diffraction measurement, Rietveld analysis, X-ray photoelectron spectroscopic analysis, and elemental analysis of the oxygen reduction catalyst (c6) were performed in the same manner as in Example 1.

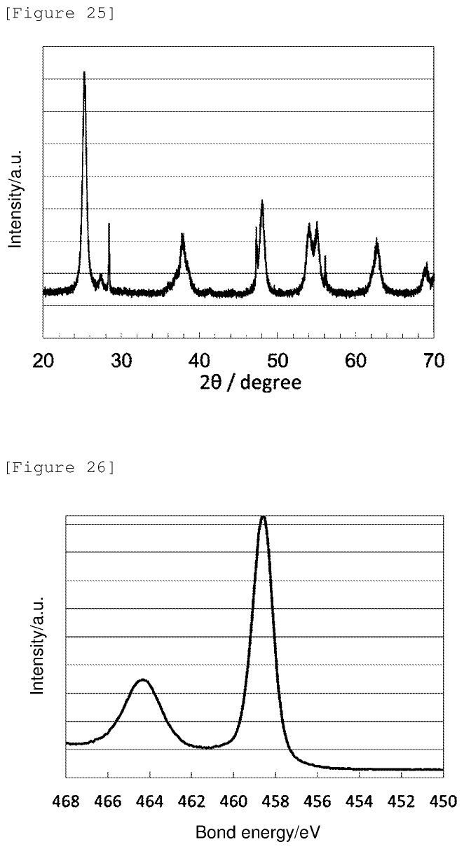

The obtained X-ray diffraction measurement spectrum and Ti2p XPS spectrum are shown in FIG. 25 and FIG. 26, respectively. The oxygen reduction catalyst (c6) had a rutile content ratio of 7 mol %, and did not have the crystal structure of rutile titanium dioxide.

Also, the nitrogen element content (mass %) obtained by an elemental analysis of the oxygen reduction catalyst (c6), the signal intensity ratio N—Ti—N/O—Ti—N determined by an X-ray photoelectron spectroscopic analysis, the peak position determined as a bond energy at which the highest intensity was obtained in 458.0 to 459.5 eV, and the electrode potential and the spontaneous potential determined by an electrochemical measurement are shown together in Table 1B.

### (3) Transmission Electron Microscope (TEM) Observation

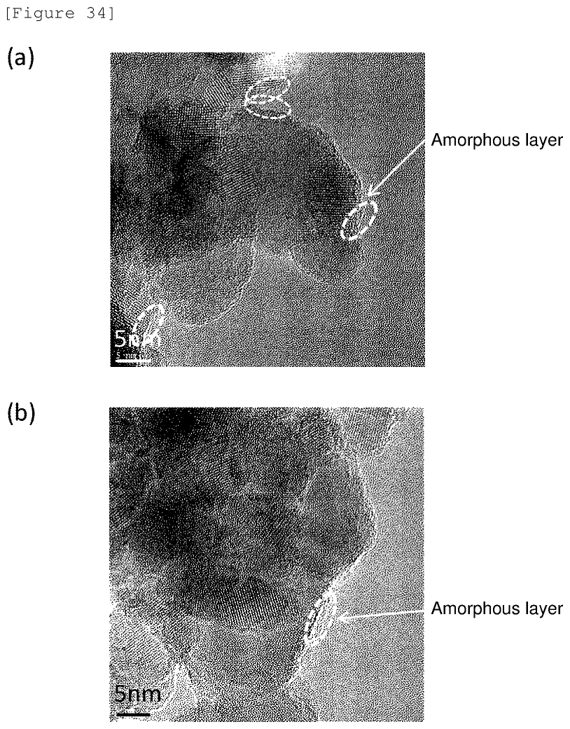

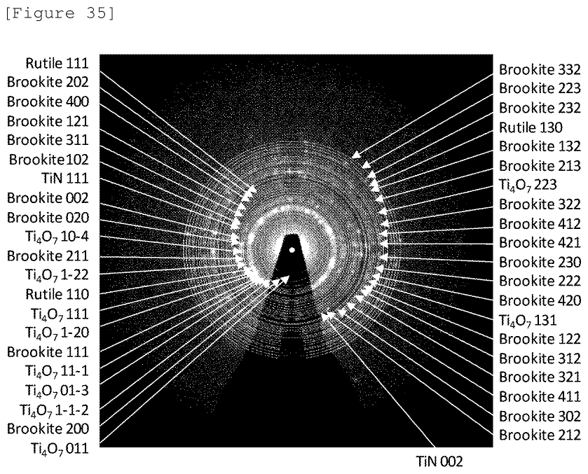

A bright field image of the oxygen reduction catalyst (c6) was photographed in the same manner as in Example 1. The TEM photographs of the oxygen reduction catalyst (c6) are shown in FIGS. 34 (a) and (b). It was confirmed that the catalyst had an amorphous layer in the surface layer having a thickness of 10 nm of a titanium oxide particle.

In addition, an electron diffraction pattern was acquired for the oxygen reduction catalyst (c6) from a region having a diameter of 200 nm using a selector aperture. The obtained electron diffraction pattern is shown in FIG. 33. It was confirmed that it had the crystal structures of titanium oxide of rutile and Ti₄O₇, and cubic titanium nitride together with the anatase crystal structure.

### Comparative Example 7

### (1) Preparation of Oxygen Reduction Catalyst

The oxygen reduction catalyst (c7) was obtained by performing temperature increase and calcination in the same manner as in Example 1 except that the rutile titanium dioxide powder was changed to a brookite titanium dioxide powder (Nano Titania®, product name: NTB®-200, manufactured by Showa Denko K.K.).

### (2) Electrochemical Measurement, Powder X-Ray Diffraction Measurement, Rietveld Analysis, X-Ray Photoelectron Spectroscopic Analysis, and Elemental Analysis

The electrochemical measurement, powder X-ray diffraction measurement, Rietveld analysis, X-ray photoelectron spectroscopic analysis, and elemental analysis of the oxygen reduction catalyst (c7) were performed in the same manner as in Example 1.

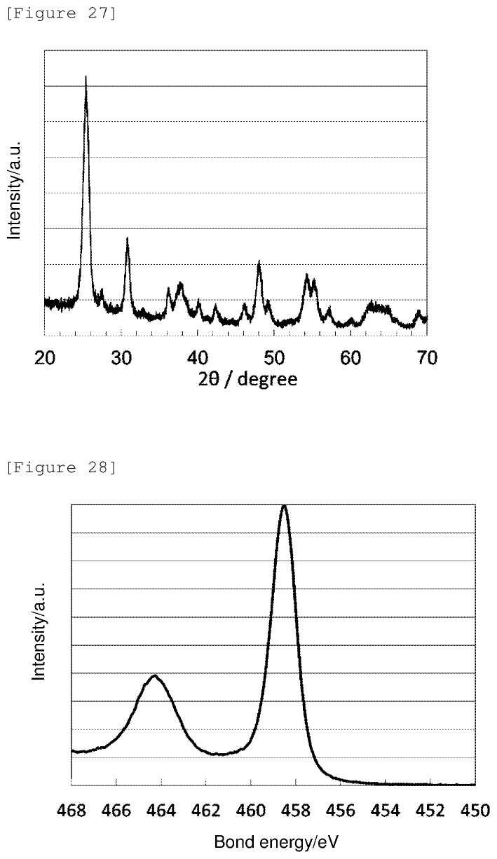

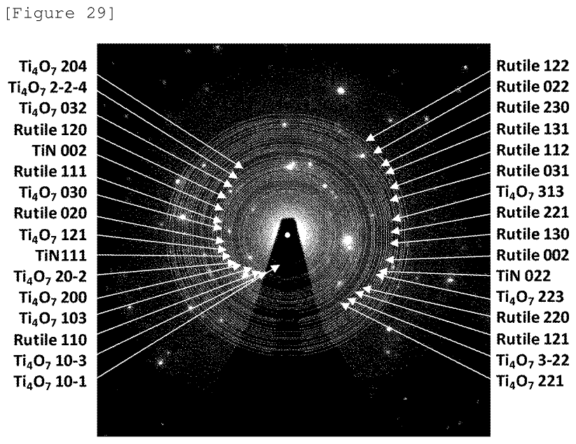

The obtained X-ray diffraction spectrum and Ti2p XPS spectrum are shown in FIG. 27 and FIG. 28, respectively. The oxygen reduction catalyst (c4) had a rutile content ratio of 11 mol %, and did not have the crystal structure of rutile titanium dioxide.

Also, the nitrogen element content (mass %) obtained by an elemental analysis of the oxygen reduction catalyst (c7), the signal intensity ratio N—Ti—N/O—Ti—N determined by an X-ray photoelectron spectroscopic analysis, the peak position determined as a bond energy at which the highest intensity was obtained in 458.0 to 459.5 eV, and the electrode potential and the spontaneous potential determined by an electrochemical measurement are shown together in Table 1B.

### (3) Transmission Electron Microscope (TEM) Observation

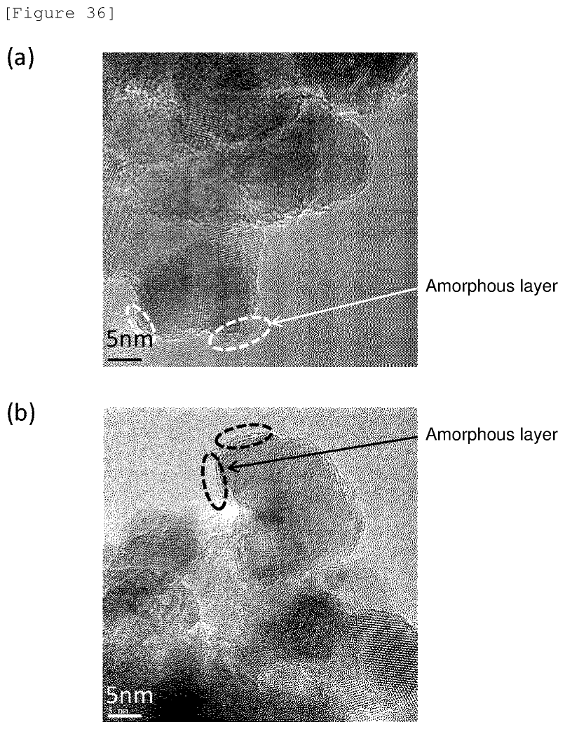

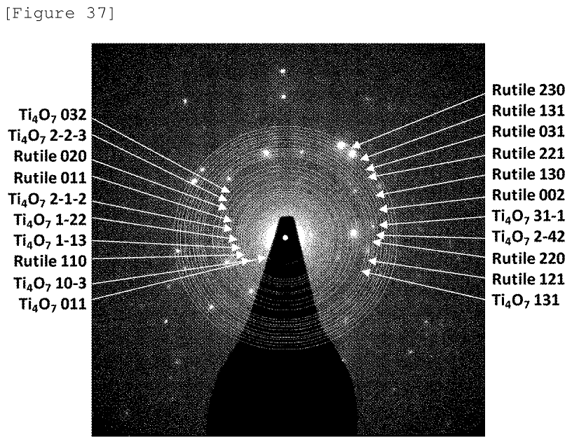

A bright field image of the oxygen reduction catalyst (c7) was photographed in the same manner as in Example 1. The TEM photographs of the oxygen reduction catalyst (c7) are shown in FIGS. 36 (a) and (b). It was confirmed that the catalyst had an amorphous layer in the surface layer having a thickness of 10 nm of a titanium oxide particle.

In addition, an electron diffraction pattern was acquired for the oxygen reduction catalyst (c7) from a region having a diameter of 200 nm using a selector aperture. The obtained electron diffraction pattern is shown in FIG. 35. It was confirmed that it had the crystal structures of titanium oxide of rutile and Ti₄O₇, and cubic titanium nitride together with the brookite crystal structure.

TABLE 1A

| | | | | | | | Signal | | | |
|---|---|---|---|---|---|---|---|---|---|---|
| | | Nitrogen | Existence | Lattice constants of rutile | | | intensity | Peak position | | Spontaneous |
| | | element | of rutile | titanium dioxide (Å) | | | ratio | in range of | Electrode | potential in |
| | Catalyst | content | titanium | a | b | c | N—Ti—N/ | 458.0 to 459.5 | potential at | oxygen gas |
| | name | (mass %) | dioxide | \|a1 − a0\| | \|b1 − b0\| | \|c1 − c0\| | O—Ti—N | eV (eV) | 10 μA (V) | atmosphere (V) |
| Example 1 | Oxygen | 0.1 | Yes | 4.592 | 4.592 | 2.958 | 0.02 | 458.4 | 0.387 | 0.631 |
| | reduction | | | 0.002 | 0.002 | 0.001 | | | | |
| | catalyst (1) | | | | | | | | | |
| Example 2 | Oxygen | 0.3 | Yes | 4.593 | 4.593 | 2.958 | 0.07 | 458.5 | 0.389 | 0.637 |
| | reduction | | | 0.001 | 0.001 | 0.001 | | | | |
| | catalyst (2) | | | | | | | | | |
| Example 3 | Oxygen | 0.5 | Yes | 4.593 | 4.593 | 2.958 | 0.12 | 458.6 | 0.370 | 0.670 |
| | reduction | | | 0.001 | 0.001 | 0.001 | | | | |
| | catalyst (3) | | | | | | | | | |
| Example 4 | Oxygen | 0.6 | Yes | 4.593 | 4.593 | 2.958 | 0.17 | 458.6 | 0.369 | 0.650 |
| | reduction | | | 0.001 | 0.001 | 0.001 | | | | |
| | catalyst (4) | | | | | | | | | |
| Example 5 | Oxygen | 0.7 | Yes | 4.593 | 4.593 | 2.958 | 0.19 | 458.7 | 0.364 | 0.719 |
| | reduction | | | 0.001 | 0.001 | 0.001 | | | | |
| | catalyst (5) | | | | | | | | | |
| Example 6 | Oxygen | 0.8 | Yes | 4.593 | 4.593 | 2.958 | 0.17 | 458.6 | 0.369 | 0.701 |
| | reduction | | | 0.001 | 0.001 | 0.001 | | | | |
| | catalyst (6) | | | | | | | | | |
| Example 7 | Oxygen | 1.6 | Yes | 4.593 | 4.593 | 2.958 | 0.48 | 458.6 | 0.361 | 0.647 |
| | reduction | | | 0.001 | 0.001 | 0.001 | | | | |
| | catalyst (7) | | | | | | | | | |

TABLE 1B

| | | | | | | | Signal | | | |
|---|---|---|---|---|---|---|---|---|---|---|
| | | Nitrogen | Existence | Lattice constants of rutile | | | intensity | Peak position | | Spontaneous |
| | | element | of rutile | titanium dioxide (Å) | | | ratio | in range of | Electrode | potential in |
| | Catalyst | content | titanium | a | b | c | N—Ti—N/ | 458.0 to 459.5 | potential at | oxygen gas |
| | name | (mass %) | dioxide | \|a1 − a0\| | \|b1 − b0\| | \|c1 − c0\| | O—Ti—N | eV (eV) | 10 μA (V) | atmosphere (V) |
| Comparative | Oxygen | 3.9 | Yes | 4.593 | 4.593 | 2.958 | 0.46 | 458.5 | 0.337 | 0.613 |
| Example 1 | reduction | | | 0.001 | 0.001 | 0.001 | | | | |
| | catalyst (c1) | | | | | | | | | |
| Comparative | Oxygen | 4.8 | Yes | 4.593 | 4.593 | 2.958 | 0.63 | 458.6 | 0.341 | 0.612 |
| Example 2 | reduction | | | 0.001 | 0.001 | 0.001 | | | | |
| | catalyst (c2) | | | | | | | | | |
| Comparative | Oxygen | 19 | No | 4.593 | 4.593 | 2.958 | 0.79 | 458.4 | 0.332 | 0.592 |
| Example 3 | reduction | | | 0.001 | 0.001 | 0.001 | | | | |
| | catalyst (c3) | | | | | | | | | |
| Comparative | Oxygen | 22 | No | — | — | — | 0.79 | 458.4 | 0.330 | 0.603 |
| Example 4 | reduction | | | | | | | | | |
| | catalyst (c4) | | | | | | | | | |
| Comparative | Oxygen | 0 | Yes | 4.592 | 4.592 | 2.958 | 0 | 459.0 | 0.338 | 0.614 |
| Example 5 | reduction | | | 0.002 | 0.002 | 0.001 | | | | |
| | catalyst (c5) | | | | | | | | | |
| Comparative | Oxygen | 0.8 | No | — | — | — | 0.02 | 458.6 | 0.346 | 0.575 |
| Example 6 | reduction | | | | | | | | | |
| | catalyst (c6) | | | | | | | | | |
| Comparative | Oxygen | 0.8 | No | — | — | — | 0.01 | 458.5 | 0.340 | 0.580 |
| Example 7 | reduction | | | | | | | | | |
| | catalyst (c7) | | | | | | | | | |

1. An oxygen reduction catalyst being a titanium oxynitride that has a nitrogen element content of 0.1 to 2.0 mass %, has a crystal structure of rutile titanium dioxide in a powder X-ray diffraction measurement, and has a signal intensity ratio N—Ti—N/O—Ti—N in an X-ray photoelectron spectroscopic analysis of in the range of 0.01 to 0.50.

2. The oxygen reduction catalyst according to claim 1, wherein each of |a1-a0|, |b1-b0|, and |c1-c0| is 0.005 Å or less, when a1, b1, and c1 represent lattice constants a, b, and c, respectively, of the titanium oxynitride, and a0, b0, and c0 represent lattice constants a, b, and c, respectively, of rutile titanium dioxide consisting solely of titanium and oxygen.

3. An electrode catalyst for a fuel cell, composed of the oxygen reduction catalyst according to claim 1.

4. A fuel cell electrode comprising a catalyst layer comprising the electrode catalyst for a fuel cell according to claim 3.

5. A membrane electrode assembly comprising a cathode, an anode, and a polymer electrolyte membrane placed between the cathode and the anode, wherein at least either of the cathode and the anode is the fuel cell electrode according to claim 4.

6. A fuel cell comprising the membrane electrode assembly according to claim 5.

7. An oxygen reduction catalyst comprising titanium oxide particles, wherein the oxygen reduction catalyst is a titanium oxynitride that has a crystal structure of rutile titanium dioxide in a powder X-ray diffraction measurement, and has an amorphous layer in a surface layer having a thickness of 10 nm of the titanium oxide particles when observed with a transmission electron microscope.

8. The oxygen reduction catalyst according to claim 7 further having a crystal structure of Ti₄O₇ in the surface layer having a thickness of 10 nm, when observed with a transmission electron microscope.

9. The oxygen reduction catalyst according to claim 8 further having a crystal structure of cubic titanium nitride in the surface layer having a thickness of 10 nm, when observed with a transmission electron microscope.

10. The oxygen reduction catalyst according to claim 8 not having a crystal structure of cubic titanium nitride in the surface layer having a thickness of 10 nm, when observed with a transmission electron microscope.

11. An electrode catalyst for a fuel cell, composed of the oxygen reduction catalyst according to claim 7.

12. A fuel cell electrode comprising a catalyst layer comprising the electrode catalyst for a fuel cell according to claim 11.

13. A membrane electrode assembly comprising a cathode, an anode, and a polymer electrolyte membrane placed between the cathode and the anode, wherein at least either of the cathode and the anode is the fuel cell electrode according to claim 12.

14. A fuel cell comprising the membrane electrode assembly according to claim 13.
